(19) United States
(12) Patent Application Publication
(10) Pub. No.: US 2024/0221029 A1
(43) Pub. Date: Jul. 4, 2024

(54) APPARATUSES, METHODS, AND COMPUTER PROGRAM PRODUCTS FOR GENERATING EXTERNAL SERVICE CANDIDATE COMMUNICATIONS WITHIN AN EXECUTABLE RESOURCE MANAGEMENT SYSTEM

(71) Applicants: ATLASSIAN PTY LTD., Sydney (AU); ATLASSIAN (US) LLC, San Francisco, CA (US)

(72) Inventors: Fan Jiang, Mountain View, CA (US); Angela Feng, San Francisco, CA (US); Prasad Thammineni, Berkeley, CA (US); Sue Huang, Redwood City, CA (US); Michael Lee, Belmont, CA (US)

(21) Appl. No.: 18/147,195

(22) Filed: Dec. 28, 2022

(51) Int. Cl. G06Q 30/0251

(52) U.S. Cl. CPC G06Q 30/0254

(57) ABSTRACT

An executable resource management system provides for generating an external service candidate communication based on a candidate selection score and a candidate selection context. The candidate selection score is generated using one or more candidate selection scoring models. The candidate selection context comprises a mapping of a candidate element with an internal executable resource and is generated based on communication corpus metadata and internal executable resource data. The score may represent semantic similarity between a given candidate element and a past candidate element, a classification of the given candidate element into a category represented by a semantically similar past candidate element, and/or an association between the given candidate element and a communication operation associated with a semantically similar past candidate element.

### BACKGROUND

Conventional systems for generating external service candidate communications for transmission to external services suffer from many deficiencies and problems. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In an embodiment, an apparatus is provided comprising at least one processor and at least one non-transitory computer-readable storage medium storing instructions. When executed by the at least one processor, the instructions cause the apparatus to, for each external service candidate communication of a plurality of external service candidate communications, generate one or more candidate selection scores using one or more trained candidate selection scoring models, generate one or more candidate selection contexts, determine an external service of a plurality of external services to which the external service candidate communication should be transmitted, generate the external service candidate communication based at least in part on the one or more candidate selection scores, the one or more candidate selection contexts, and the determined external service to which the external service candidate communication should be transmitted, and transmit the external service candidate communication to the external service. Each candidate selection context comprises a mapping of a candidate element with an internal executable resource of a plurality of internal executable resources, and the candidate selection context is generated based at least in part on communication corpus metadata and internal executable resource data. The internal executable resource data comprises interaction events representing electronic interactions performed by client computing devices with respect to one or more internal executable resources of the plurality of internal executable resources.

In another embodiment, a computer-implemented method is provided. The computer-implemented method provides for a series of method steps performed by one or more processors, including, for each external service candidate communication of a plurality of external service candidate communications, generating one or more candidate selection scores using one or more trained candidate selection scoring models, generating one or more candidate selection contexts, determining an external service of a plurality of external services to which the external service candidate communication should be transmitted, generating the external service candidate communication based at least in part on the one or more candidate selection scores, the one or more candidate selection contexts, and the determined external service to which the external service candidate communication should be transmitted, and transmitting the external service candidate communication to the external service. Each candidate selection context comprises a mapping of a candidate element with an internal executable resource of a plurality of internal executable resources, and the candidate selection context is generated based at least in part on communication corpus metadata and internal executable resource data. The internal executable resource data comprises interaction events representing electronic interactions performed by client computing devices with respect to one or more internal executable resources of the plurality of internal executable resources.

In another embodiment, a computer program product, stored on a computer readable medium, is provided. The computer program product comprises instructions that when executed by one or more computers cause the one or more computers to, for each external service candidate communication of a plurality of external service candidate communications, generate one or more candidate selection scores using one or more trained candidate selection scoring models, generate one or more candidate selection contexts, determine an external service of a plurality of external services to which the external service candidate communication should be transmitted, generate the external service candidate communication based at least in part on the one or more candidate selection scores, the one or more candidate selection contexts, and the determined external service to which the external service candidate communication should be transmitted, and transmit the external service candidate communication to the external service. Each candidate selection context comprises a mapping of the candidate selection score with an internal executable resource of a plurality of internal executable resources, and the candidate selection context is generated based at least in part on communication corpus metadata and internal executable resource data. The internal executable resource data comprises interaction events representing electronic interactions performed by client computing devices with respect to one or more internal executable resources of the plurality of internal executable resources.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system architecture within which one or more embodiments of the present disclosure may operate.

FIG. 2 is a block diagram of an example apparatus configured in accordance with one or more embodiments of the present disclosure.

FIG. 3 is a dataflow diagram illustrating an example process for receiving, generating, maintaining, updating, and/or storing data used to generate external service candidate communications.

FIG. 4 illustrates an example computing environment for generating candidate selection scores for external service candidate communications using one or more candidate selection scoring models and for generating external service candidate communications, in accordance with at least some example embodiments of the present disclosure.

FIG. 5 is a flowchart diagram of an example process for generating and transmitting external service candidate communication according to at least some example embodiments of the present disclosure.

FIG. 6 is an illustration of an exemplary score presentation interface of a graphical user interface configured by an executable resource management system according to at least some example embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently generating external service candidate communications for transmission to external services within an executable resource management system that maintains a plurality of internal executable resources. The disclosed techniques can be utilized by an executable resource management system to provide external service candidate communications that enhance effectiveness and/or efficiency of communicating with external services with respect to complex data sets maintained by executable resource management systems with a plurality of internal executable resources.

An executable resource management system for maintaining and/or distributing a plurality of internal executable resources (e.g., software applications or services) typically maintains a complex body of data concerning the plurality of internal executable resources, including independently maintained and/or stored code bases for each of the plurality of internal executable resources, user account data for users of the internal executable resources, access permissions data, internal executable resource data generated with respect to the plurality of internal executable resources, renderable content (e.g., web content) maintained and/or provided for each of the plurality of internal executable resources, metadata pertaining to the renderable content (e.g., web traffic statistics, user-generated data submitted via user interfaces within the renderable content), and/or transaction data and distribution data (e.g., sales, downloads) for each of the plurality of internal executable resources, to list a few examples. Such systems may maintain the aforementioned data with respect to each one of the plurality of internal executable resources, resulting in a complex corpus of data sourced from front end and back end aspects of the executable resource management system across multiple internal executable resources. As a result, communicating with external services concerning communication opportunities and transaction proposals for presenting renderable content associated with the internal executable resources in a manner that fully takes advantage of the extensive body of data available to the executable resource management system can be difficult. By the time a manual or brute force analysis of such expansive data in order to generate communications intended for external services can be completed, the data will have lost its meaning or relevance. Even an automated analysis of such expansive data can consume computational resources unnecessarily. Moreover, without the ability to properly analyze the broadly-sourced data available to the executable resource management system in the context of communicating with external services, such a system can be placed at a disadvantage with respect to determining optimal parameters for communication with the external service.

To address the above-described challenges related to generating communications for transmission to external services within an executable resource management system, various embodiments of the present disclosure are directed to systems, apparatuses, methods and/or computer program products for generating external service candidate communications (e.g., for causing renderable content to be presented within an interface of a client device according to a requested transaction) based at least in part on candidate selection scores generated using one or more machine learning models. In one or more embodiments, a candidate selection score associated with an external service candidate communication may represent a classification label assigned to a candidate element (e.g., text element or keyword) associated with the external service candidate communication, based on which the external service candidate communication and/or corresponding metadata may be generated. The one or more machine learning models used to generate the candidate selection scores may be trained on the extensive body of data available to the executable resource management system (or any portions thereof), including, for example, a candidate communication corpus, communication corpus metadata, and/or internal executable resource data, allowing the executable resource management system to extract important features from the body of data that can be used to optimize communications with the external services while disregarding unimportant features. Additionally, generating communications based on such an extensive body of data enables a reduction in the quantity of communications necessary in communicating with external services, as communication parameters determined for each communication are better informed. As a result, fewer transmissions of such communications are necessary, resulting in reduced strain on network resources.

By using the described techniques, various embodiments of the present disclosure provides generation of external service candidate communications for transmission to external services using machine learning models trained on data sourced from and/or with respect to a plurality of internal executable resources. In doing so, various embodiments of the present disclosure make substantial technical contributions to improving the efficiency and/or the effectiveness of generating communications for transmission to external services and evaluating the effectiveness of previously generated communications. Various embodiments of the present disclosure additionally or alternatively provide improved understanding of correlations and/or relationships between various items of data maintained for a plurality of internal executable resources and the likelihood of electronic interactions with renderable content associated with the plurality of internal executable resources.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “client computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the client device may comprise computer hardware and/or software that is configured to access, communicate with, and/or execute a plurality of internal executable resources and/or data (e.g., digital or web content) about the plurality of internal executable resources made available by one or more servers or server computing devices of an executable resource management system. The client device may also be configured to access data (e.g., digital or web content) provided by one or more servers or server computing devices external with respect to the executable resource management system. The server is often, but not always, on another computer system, in which case the client accesses the data and/or executable resources by way of a network. Embodiments of client devices may include, without limitation, desktop computers, laptop computers, smartphones, netbooks, tablet computers, and/or other networked device, that may be used for any suitable purpose in addition to executing components and/or instances of internal executable resources, presenting data about the internal executable resources, receiving and/or generating (e.g., based on user input) data associated with the internal executable resources, and otherwise providing access to the executable resource management system. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

The term “server computing device” or “server” refers to a combination of computer hardware and/or software that is configured to provide data (e.g., executable resource data, digital or web content) and/or executable resources to a client device. The server computing device may also be configured to communicate with other server computing devices, for example, in order to provide the data to the client device. Examples of a server computing device include the executable resource management system and/or any servers thereof, the external service, or any server that provides digital or web content to the client device. In some embodiments, a server computing device communicates with one or more client computing devices and/or one or more other server computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “executable resource” may refer to computer program products that comprise software and/or firmware instructions (e.g., stored on one or more computer readable memory devices and/or transmittable over a network) that work together to cause an apparatus, such as a client computing device or a server computing device, to perform one or more functions attributed to the executable resource. The executable resource may be a software product or application developed and/or distributed by an executable resource providing entity (e.g., software technology company) to client computing devices via one or more server systems.

The term “internal” refers to resources, data, components, functions, and/or services generated within, maintained by, stored by, distributed by, and/or controlled by an executable resource management system. For example, an internal executable resource of an executable resource management system may be an executable resource that is maintained by and/or distributed to client computing devices by the executable resource management system.

The term “executable resource management system” may refer to one or more server computing devices and data repositories configured to provide access to and/or maintain a plurality of internal executable resources. The executable resource management system may be configured to provide access by one or more client computing devices to a selected one or more of the plurality of internal executable resources. The executable resource management system may provide access to the internal executable resources by sending copies and/or components of the internal executable resources (e.g., in the form of one or more data files transmitted over a network) to the client computing devices to execute locally on the client computing devices. The executable resource management system may provide access to the internal executable resources by receiving access requests from the client computing devices, executing, based at least in part on the access requests, the internal executable resources on the executable resource management system (e.g., remotely with respect to the client computing devices), and sending responses to the client computing devices based on the remote execution of the internal executable resources. The executable resource management system may provide access to the internal executable resources via a combination of providing the copies and/or components of the internal executable resources to execute locally on the client computing devices and providing remote execution of copies, instances, and/or components of the executable resources on behalf of the client computing devices. For example, in order to perform the overall functionality attributed to the internal executable resources, the executable resource management system may receive access requests by local components of the internal executable resources executing on the client computing devices for remote execution of remote components of the internal executable resources.

In various embodiments, the executable resource management system may be configured to provide data concerning internal executable resources to the client computing devices via, for example, renderable content (e.g., digital or web content) generated with respect to one or more of the executable resources maintained by the executable resource management system.

The executable resource management system may be configured to detect and/or capture interaction events with respect to the plurality of executable resources, including interaction events between client computing devices and the plurality of executable resources and/or interaction events between client computing devices and the executable resource management system. The interaction events may represent electronic interactions detected between the client computing devices and executing instances of one or more internal executable resources and/or electronic interactions detected between the client computing devices and renderable content associated with the one or more internal executable resources. The executable resource management system may be configured to generate and/or store internal executable resource data indicative of the detected and/or captured interaction events.

In one example, the executable resource management system may be operated by an executable resource providing entity in order to develop, deploy, sell, distribute, and/or provide support for a suite of software products. The software products may be hosted by server devices of the executable resource management system, may run locally on client computing devices, or a combination thereof. The executable resource management system may also provide various forms of renderable content (e.g., web content, including user-generated web content) for providing data about the software products, providing customer support, and/or facilitating distribution of the software products (e.g., e-commerce transactions for purchasing the products, downloading of the products), to list a few examples.

In various embodiments, a particular internal executable resource may comprise executable code (e.g., defining software and/or firmware instructions that cause an apparatus or computing device to perform the one or more functions attributed to the particular internal executable resource) specific to the particular internal executable resource. In one example, each particular internal executable resource of an executable resource management system may comprise an executable code base specific to the particular internal executable resource and separate from other internal executable resources of the same executable resource management system (e.g., stored separately from the other internal executable resources, executing independently with respect to the other internal executable resources). In some embodiments, each particular internal executable resource of an executable resource management system may be initiated, operated, and/or interacted with independently with respect to the other internal executable resources of the executable resource management system.

The term “external” refers to resources, data, components, functions, and/or services provided by and/or controlled by entities (e.g., other server computing devices) outside the executable resource management system. For example, while the executable resource management system may control processes executed on client computing devices by local components of internal executable resources distributed by the executable resource management system by virtue of the executable resource management system maintaining and/or distributing the internal executable resources to the client computing devices, the executable resource management system may interact with but may not control processes executed and/or performed by other server computing systems external to the executable resource management system and/or by client computing devices outside the scope of the local components of the internal executable resources.

The term “external service” may refer to a server computing device external with respect to the executable resource management system, with which the executable resource management system communicates. The external service may receive communications from the executable resource management system (e.g., over a network such as a wide area network) and/or from other systems (e.g., external with respect to the executable resource management system) and execute processes (e.g., remotely with respect to the executable resource management system) based at least in part on the communications received from the executable resource management system and the other systems. The processes executed by the external service based at least in part on the communications received from the executable resource management system may further be based at least in part on predetermined instructions generated, stored, and/or maintained by the external service and outside the scope of control of the executable resource management system. In one example, the external service may receive communications from the executable resource management system in the form of candidate communications that may cause renderable content to be presented (e.g., to client computing devices) according to a requested transaction associated with the candidate communication. External services can include search engine services, social networks, and/or sponsored content distribution services, to list a few examples.

The term “external service communication server” may refer to a component of the executable resource management system that manages communication with an external service. The external service communication server may comprise executable computer code that, when executed by a processing element or device of the executable resource management system, may cause the functionality attributed to the external service communication server. The external service communication server may be configured to receive, generate, maintain, update, and/or store data used to generate communications to be transmitted to the external services (e.g., candidate communication corpus, communication corpus metadata, internal executable resource data). The external service communication server may be configured to generate an external service candidate communication and/or transmit the external service candidate communication to the external service. The external service communication server may be configured to generate a plurality of external service candidate communications and/or transmit a plurality of external service candidate communications to the same external service or to a plurality of different external services, or a combination thereof. For each external service candidate, the external service communication server may be configured to generate one or more candidate selection scores (e.g., using one or more candidate selection scoring models), generate one or more candidate selection context, determine an external service from a plurality of external services to which the given external service candidate communication should be transmitted, generate the external service candidate communication based at least in part on the one or more candidate selection scores, the one or more candidate selection contexts, and the determined external service to which the external service candidate communication should be transmitted, and transmit the external service candidate communication to the external service.

The term “external service candidate communication” refers to a data construct that describes data transmitted to the external service. The external service candidate communication may be generated by the external service communication server and/or transmitted from the external service communication server to an external service. Subsequent to transmission of the external service candidate communication to the external service, the external service candidate communication may cause renderable content to be presented (e.g., to client computing devices) according to a requested transaction associated with the candidate communication. The external service candidate communication may comprise particular data parameters and/or formatting expected by the external service. The external service candidate communication may comprise one or more renderable content identifiers for requesting the renderable content, which may be presented within an interface subsequent to transmission of the external service candidate communication to the external service. The external service communication server may determine the one or more renderable content identifiers included in the external service candidate communication based at least in part on a candidate selection context generated by the external service communication server for the external service candidate communication.

The external service candidate communication may comprise and/or may be associated with one or more candidate elements, including text elements extracted from a candidate communication corpus, which one or more candidate elements may cause the renderable content to be presented in certain situations associated with the one or more candidate elements. The external service communication server may determine the one or more candidate elements included in and/or associated with the external service candidate communication based at least in part on a candidate selection score generated by the external service communication server. The external service candidate communication may comprise and/or may be associated with one or more candidate selection classifications respectively corresponding to the one or more candidate elements, and the external service candidate communication may be generated based at least in part on the one or more candidate selection classifications. The external service candidate communication may constitute and/or comprise a communication opportunity request representing a request for the renderable content to be presented according to a requested transaction associated with the external service candidate communication. The external service candidate communication may comprise various attributes associated with, representing, indicative of, and/or characterizing the requested transaction, including, for example, an exchange value representing an amount of a medium exchange (e.g., a monetary value) transferred from an entity associated with the executable resource management system to an external entity (e.g., the external service) in conjunction with presenting the renderable content identified in the external service candidate communication. The requested transaction and/or attributes associated with the requested transaction (e.g., the exchange value) may be determined by the external service communication server based at least in part on the candidate selection score and/or the candidate selection context generated for the external service candidate communication, and/or the determined external service to which the communication is to be transmitted.

The external service candidate communication may comprise one or more candidate elements (e.g., text elements, keywords), one or more candidate selection contexts associated with the candidate elements, one or more classifications and/or attributes associated with the candidate elements (e.g., candidate selection classifications, themes, communication operations or campaigns, renderable content identifiers).

The term “candidate selection score” may refer to a data construct representing one or more programmatically generated features, attributes, and/or values based on which the executable resource management system generates the external service candidate communications and/or which may be associated with one or more external service candidate communications. The candidate selection score may be generated based at least in part on the candidate communication corpus, the communication corpus metadata, and/or the internal executable resource data. For example, the candidate selection score may be generated using one or more candidate selection scoring models trained on a candidate communication corpus, communication corpus metadata, and/or internal executable resource data, and/or which may be configured to generate the candidate selection scores based at least in part on input including the candidate communication corpus, the communication corpus metadata, and/or the internal executable resource data. The candidate selection score may be generated based at least in part on the communication corpus metadata and/or the internal executable resource data. The candidate selection score may be associated with a candidate element such as a text element extracted from one or more raw text objects of the candidate communication corpus.

In some embodiments, a candidate selection score may refer to a data construct representing a similarity between a candidate element context of a given candidate element and a candidate element context of a past candidate element (e.g., known, previously generated, previously stored, previously used). The given candidate element may be a text element that is newly extracted from one or more raw text objects of the candidate communication corpus, for example. The past candidate element may be a text element that is already known by the executable resource management system such as one for which one or more external service candidate communications have been previously generated. The past candidate element may be associated with and/or representative of a category of candidate elements of which the past candidate element is an example. The candidate selection score may be used to categorize the given candidate element, for example, by assigning a label or tag indicating that the given candidate element is in a category represented by the assigned label or tag (e.g., in the communication corpus metadata associated with the given candidate element). In one example, the executable resource management system may be configured to, using the one or more candidate selection scoring models, generate the candidate selection score for a given candidate element by vectorizing the given candidate element and one or more past candidate elements, calculating a cosine similarity with respect to the vectorized given candidate element and each of the one or more past candidate elements and to assign a classification label to the given candidate element based at least in part on the calculated cosine similarity or similarities. The executable resource management system may be configured to use a candidate selection scoring model (e.g., a natural language processing model trained on and/or fine-tuned with the candidate communication corpus) of the one or more candidate selection scoring models to generate the candidate element context for the given candidate element and the one or more past candidate elements and/or vectorize the given candidate element and the one or more past candidate elements.

In some embodiments, a candidate selection score may refer to a candidate selection classification, which is a data construct representing a classification label assigned to a given candidate element (e.g., based at least in part on calculated cosine similarity between a candidate element context of the given candidate element and that of one or more past candidate elements), based on which the executable resource management system may generate external service candidate communications associated with the given candidate element and/or which may be associated with any external service candidate communications generated with respect to the given candidate element. For example, the executable resource management system may be configured to, using the one or more candidate selection scoring models, at least one of which may be trained on the candidate communication corpus, generate the candidate selection score by assigning a classification label to a given candidate element (e.g., in the communication corpus metadata) as being in a category represented by a selected past candidate element of one or more past candidate elements, in response to determining that a calculated cosine similarity between the candidate element context of the given candidate element and that of the selected past candidate element indicates that the given candidate element is most similar to the selected past candidate element relative to the similarity between the given candidate element and any other past candidate elements. The executable resource management system may be configured to assign the classification label to the given candidate element indicating that the given candidate element is in a category represented by the selected past candidate element only in response to determining that the calculated cosine similarity between the candidate element context of the given candidate element and that of the selected past candidate element is within a predetermined similarity threshold. On the other hand, in response to determining that the calculated cosine similarity between the candidate element context of the given candidate element and that of any of the one or more past candidate elements is not within the predetermined similarity threshold, the executable resource management system may be configured to generate and/or assign a tag indicating that a new category should be created, generate and/or transmit (e.g., to one or more client computing devices) a notification indicating that a new category should be created, and/or to generate the new category and assign the given candidate element to the newly created category.

In some examples, the candidate selection score and/or candidate selection classification associated with a given candidate element may represent a communication operation with which the given candidate element is associated. A communication operation may refer to a data construct representing and/or characterizing an organization of external service candidate communications and/or candidate elements into groups corresponding to different sets of protocols, methods, formats, attributes, characteristics, and/or values used to generate external service candidate communications with respect to the given candidate elements and/or associated with any external service candidate communications associated with the given candidate elements. In one example, the executable resource management system may be configured to determine how an external service candidate communication is generated and/or transmitted and/or to generate an external service candidate communication based at least in part on a communication operation associated with the external service candidate communication and/or one or more candidate elements associated with the external service candidate communication. The communication operation may determine how external service candidate communications are generated and/or transmitted by characterizing and/or otherwise indicating, for example, how generation of the external service candidate communications is indicated, scheduled, and/or executed and/or how contents (e.g., data values, attributes) of individual external service candidate communications are determined. In one example, one or more candidate elements may be assigned to and/or otherwise associated with a communication operation, and the executable resource management system may generate any external service candidate communications associated with the one or more candidate elements based at least in part on the communication operation with which the one or more candidate elements are associated. In one example, the executable resource management system may be configured to include candidate selection classification(s) corresponding to any candidate elements associated with a given external service candidate communication as part of the given external service candidate communication and/or metadata describing the given external service candidate communication. The given external service candidate communication and/or the metadata describing the given external service candidate communication, including the candidate selection classification(s) associated with the given external service candidate communication, may be stored (e.g., as part of the internal executable resource data and/or communication corpus metadata) for future analysis and/or use.

In some embodiments, a candidate selection score and/or candidate selection classification may refer to a data construct representing an association between a given candidate element and a communication operation. For example, the executable resource management system may be configured to generate the candidate selection score by, using one or more candidate selection scoring models (at least one of which may be trained on the candidate communication corpus), assigning a classification label to the given candidate element, the assigned classification label representing a selected communication operation with which the given candidate element is associated. The executable resource management system may be configured to generate any external service candidate communications associated with a given candidate element based at least in part on the candidate selection score by virtue of, for example, generating the communications based at least in part on the communication operation assigned to the given candidate element via the candidate selection score. In a similar example, the executable resource management system may be configured to generate one or more external service candidate communications for a given communication operation based at least in part on the candidate selection score by virtue of, for example, generating the communications based at least in part on one or more candidate elements assigned to the given communication operation via one or more candidate selection scores and/or generating an external service candidate communication for each candidate element assigned to the given communication operation via a candidate selection score.

In some embodiments, a candidate selection score may refer to a data construct representing a programmatically generated likelihood that renderable content (e.g., identified/retrieved via one or more renderable content identifiers of the external service candidate communication) associated with an internal executable resource (e.g., the internal executable resource mapped to the candidate selection score for the communication via the candidate selection context for the communication) and transmitted for presentation within an interface will result in an electronic interaction with the renderable content subsequent to transmission of the external service candidate communication to the external service.

In some embodiments, the candidate selection score may be generated based at least in part on past candidate elements (e.g., candidate elements previously known by the executable resource management system, candidate elements for which external service candidate communications have been previously generated) identified in the candidate communication corpus and/or communication corpus metadata. In one example, the candidate selection score may represent a candidate selection classification attributed to a candidate element and/or any external service candidate communications generated with respect to the candidate element, and the candidate selection classification may be generated based at least in part on previously classified and/or labeled past candidate elements (e.g., indicated in the communication corpus metadata) in which each of the past candidate elements is associated with a classification label. The executable resource management system may be configured to generate the candidate selection classification based at least in part on semantic similarities between a given candidate element (to be classified) and the previously classified and/or labeled past candidate elements.

In some embodiments, the candidate selection score may be generated based at least in part on communication corpus metadata associating the one or more raw text objects with one or more of the plurality of internal executable resources. The candidate selection score may be generated based at least in part on interaction events of the internal executable resource data and/or communication corpus metadata associating raw text objects of the candidate communication corpus to one or more of the interaction events. In one example, the candidate selection score used to generate an external service candidate communication representing a communication opportunity request (e.g., for presenting sponsored content associated with an internal executable resource) may represent a programmatically generated likelihood that the sponsored content will result in an electronic interaction with the sponsored content (e.g., a selection of one or more elements of the sponsored content to navigate to further content provided by the executable resource management system). In a similar example concerning sponsored content, the candidate selection score may be associated with a candidate element, namely a text element or keyword extracted from raw text objects of the candidate communication corpus and indicative of an intent and/or desire of a user.

The term “candidate selection context” may refer to a data construct representing a mapping of a candidate element with an internal executable resource of the plurality of internal executable resources. The candidate selection context may be generated based at least in part on the candidate communication corpus, the communication corpus metadata, and/or the internal executable resource data. The candidate selection context may be generated based at least in part on communication corpus metadata associating one or more raw text objects of the candidate communication corpus with one or more internal executable resources of the plurality of internal executable resources. The candidate selection context may be generated based at least in part on interaction events of internal executable resource data and/or communication corpus metadata associating raw text objects of the candidate communication corpus to one or more of the interaction events. In one example, the candidate selection context may be based at least in part on and/or representative of a predicted relevance of the candidate element to the internal executable resource being mapped to the candidate element.

The term “candidate element” may refer to a data construct representing one or more objects (e.g., represented in the candidate communication corpus, communication corpus metadata, and/or internal executable resource data) associated with the generation of the external service candidate communications. In one example, the candidate elements are text elements or keywords, some or all of which may be extracted from raw text objects of the candidate communication corpus.

In one example, the candidate element may be a text element or keyword extracted from raw text objects of the candidate communication corpus, and the candidate selection context may represent a predicted relevance of the keyword to a software product. This predicted relevance may be determined based at least in part on communication corpus metadata linking the raw text objects from which the keyword was extracted to the software product and/or based at least in part on communication corpus metadata linking the raw text objects to certain interaction events, such as detected instances of users downloading, sampling, purchasing, and/or otherwise engaging with the software product or related software products in connection with the keyword (e.g., after entering a search query or submitting user-generated content containing the keyword).

The term “renderable content identifier” may refer to a data construct identifying renderable content associated with one of the plurality of internal executable resources. One or more actions performed by and/or in conjunction with the external service subsequent to transmission of an external service candidate communication may be determined based at least in part on one or more renderable content identifiers included in the transmitted external service candidate communication. The renderable content identifiers of a transmitted external service candidate communication may cause the external service (and/or other external server devices in conjunction with the external service) to retrieve and/or present the renderable content, for example. In various embodiments, the renderable content identifier may comprise one or more addresses (e.g., URL) for retrieving elements of the renderable content, one or more formatting and/or markup tags and/or attributes (e.g., HTML, CSS) for presenting the renderable content, and/or data objects representing textual, graphical, and/or audiovisual elements of the renderable content itself.

The term “renderable content” may refer to one or more graphical, textual, audiovisual, and/or interactive interface objects presented (e.g., by a client computing device in conjunction with one or more server devices via a graphical and/or audible user interface) with respect to one or more of the plurality of internal executable resources. The renderable content may comprise data about the plurality of internal executable resources and/or interface elements for interacting with the executable resource management system, including navigating to content hosted by the executable resource management system, presenting data about one or more of the plurality of internal executable resources, requesting further data or contact from the executable resource management system concerning the internal executable resources, downloading copies and/or components of the internal executable resources, completing transactions in connection with the internal executable resources (e.g., purchases, rentals, trials, licenses, subscriptions), and/or receiving or transmitting user input such as raw text objects (e.g., web search queries, user-generated content such as forum posts, reviews, questions, feedback, suggestions), which may be received via the interface elements of the renderable content and may represent data about an intent and/or a relationship of a user with respect to one or more of a plurality of internal executable resources maintained by the executable resource management system.

The term “candidate communication corpus” may refer to a data construct representing a body of data pertaining to the plurality of internal executable resources maintained by the executable resource management system. The candidate communication corpus may comprise a plurality of raw text objects associated with the plurality of internal executable resources. The raw text objects may comprise textual data about the plurality of internal executable resources, textual data generated by client computing entities and received via one or more of the plurality of internal executable resources during interaction between the client computing entities and the internal executable resources, textual data generated by client computing entities and received via one or more servers for presenting renderable content about the plurality of internal executable resources (e.g., search queries, including search queries for searching renderable content associated with the renderable content about the plurality of internal executable resources, user-generated content such as forum posts, reviews, questions, feedback, suggestions, and/or community Q&A posts). The raw text objects of the candidate communication corpus may include textual data about the plurality of internal executable resources, including that provided by the executable resource management system as part of renderable content associated with the plurality of internal executable resources, such as marketing content associated with the internal executable resources (e.g., search engine optimization pages, product tutorials, whitepapers), user manuals and/or technical documentation for the internal executable resources, and/or technical support content associated with the internal executable resources, including technical support tickets generated via a support interface provided through the technical support content. The raw text objects of the candidate communication corpus may include textual data about executable resources other than the plurality of internal executable resources but associated with the internal executable resources, including that provided by entities external with respect to the executable resource management system but having predefined relationships with a executable resource providing entity associated with the executable resource management system (e.g., competitors, partners), including web content about executable resources that perform similar or analogous functions as one or more of the internal executable resources and/or marketing content associated with and/or provided by the external entities (e.g., periodically scraped from web pages and/or search engine results associated with the external entities). The raw text objects of the candidate communication corpus may originate from one or more user profiles for user accounts of users of the plurality of internal executable resources, including raw text objects with textual data indicating how the users use or plan to use the plurality of internal executable resources. The raw text objects of the candidate communication corpus may include text associated with each of the plurality of internal executable resources (e.g., identifying key features of the associated internal executable resource). The candidate communication corpus may comprise and/or may be associated with communication corpus metadata.

The term “communication corpus metadata” may refer to a data construct representing a body of data associated with the candidate communication corpus. The communication corpus metadata may comprise identification, timing, relational, and/or characteristic data concerning one or more discrete items of data (e.g., raw text objects) and/or groups of items of data included within the candidate communication corpus, including associations of the items of data and/or groups of items of data with items of data within one or more data repositories of the executable resource management system (e.g., repositories for storing data about the plurality of internal executable resources), including associations with items of data within the internal executable resource data. The communication corpus metadata may include timestamps, identifiers, feature tags, and/or relationship indicators and may be indicative of particular states detected within or surrounding internal server devices of the executable resource management system and/or client computing devices in communication with the executable resource management system. The communication corpus metadata may include indications of which client computing devices generated raw text objects of the candidate communication corpus and/or subsequent behavior or interaction events attributed to client computing devices that generated the raw text objects, details surrounding a computing and/or communication context within which raw text objects were generated and/or received by the executable resource management system, and/or data associating generation of the raw text objects to one or more of the plurality of internal executable resources, to list a few examples. The communication corpus metadata may comprise, identify, and/or refer to one or more candidate elements such as text elements extracted from one or more raw text objects of the candidate communication corpus. The communication corpus metadata may indicate associations of raw text objects of the candidate communication corpus and/or text elements extracted therefrom with one or more of the plurality of internal executable resources.

The communication corpus metadata may indicate associations of raw text objects of the candidate communication corpus and/or candidate elements (e.g., text elements) extracted therefrom with one or more items of data in the internal executable resource data, including any user behavior tracking data. The communication corpus metadata may indicate associations of raw text objects of the candidate communication corpus and/or text elements extracted therefrom with one or more entities having predefined relationships with an executable resource providing entity associated with the internal executable resource management system (e.g., competitor entities, partner entities)

In one example, for raw text objects originating from search engine results for a given candidate element such as a text element (e.g., raw text objects representing textual data provided via marketing content included in the search engine results), the communication corpus metadata for the given text element (and/or raw text objects) may include an indication of an external entity (e.g., competitor entity, partner entity) associated with a navigation destination associated with the raw text objects within the search engine results.

The communication corpus metadata may include data that is generated automatically in connection with generation of raw text objects of the candidate communication corpus, such as tags identifying an associated internal executable resource of the plurality of internal executable resources, which tags may be generated and assigned as part of an interface or web application based on a current context (e.g., a product tag for a particular product automatically assigned to all user-generated content posted in a particular context associated with the particular product such as a product forum).

The term “internal executable resource data” may refer to a data construct representing internally generated (e.g., by the executable resource management system) data for, about, and/or associated with the plurality of internal executable resources. The internal executable resource data may comprise identification, timing, relational, and/or characteristic data concerning one or more discrete items of data and/or groups of items of data included within one or more data repositories of the executable resource management system (e.g., for storing data about the plurality of internal executable resources maintained by the executable resource management system). The internal executable resource data may include timestamps, identifiers, feature tags, and/or relationship indicators and may be indicative of particular states detected within or surrounding internal server devices of the executable resource management system and/or client computing devices in communication with the executable resource management system. The internal executable resource data may be detected, captured, collected, and/or aggregated from across the plurality of internal executable resources, data repositories associated with the plurality of internal executable resources, and/or servers for providing renderable content associated with the plurality of internal executable resources and/or over time as historical data.

The internal executable resource data may include user behavior tracking data indicative of interactions between client devices of users and the plurality of internal executable resources and/or associated renderable content, including indications of loading by the client devices of certain types of renderable content associated with the internal executable resources (e.g., product tour pages, signup pages, product reviews), including attributes characterizing and/or statistics describing the loading by the client devices of the certain types of renderable content, including an indication of whether client computing devices load product tour pages, an indication of which internal executable resources are associated with the loaded product tour pages, frequencies of loading the product tour pages, an indication of whether client computing devices load signup pages or forms, how many page loads (e.g., of product tour pages) occur before loading of the signup pages, and/or an indication of whether signup forms and/or purchase forms are completed. The internal executable resource data may comprise any current and/or historical mapping data (e.g., previously generated candidate selection contexts) indicative of a contextual matching of candidate elements (e.g., text elements) to internal executable resources.

In various embodiments, the internal executable resource data may comprise and/or refer to execution data (e.g., logs) for each of the plurality of executable resources, the execution data indicating steps or actions performed by locally and/or remotely executing components and/or instances of the plurality of internal executable resources. The internal executable resource data may comprise and/or refer to distribution data for each of the plurality of internal executable resources, the distribution data indicating a distribution of the various internal executable resources or components thereof across various server devices and/or client computing devices, including download data and/or current deployment data for the internal executable resources. The internal executable resource data may comprise and/or refer to user data for the plurality of internal executable resources, including user identifiers, characteristic attributes, demographic data, and behavior events associated with users of the internal executable resources and/or client computing devices of these users. The internal executable resource data may comprise and/or refer to interaction data of the executable resource management system, including any interaction events detected and/or captured by the executable resource management system with respect to the plurality of internal executable resources.

The internal executable resource data may comprise and/or refer to transaction data for transactions pertaining to the plurality of internal executable resources and distribution thereof (e.g., purchases, rentals, trials, licenses, subscriptions).

The internal executable resource data may comprise and/or refer to external service candidate communications (e.g., previously generated by the external service communication server) and/or data concerning the previously generated external service candidate communications, including associations between the previously generated external service candidate communications and candidate elements (e.g., text elements) extracted from the candidate communication corpus, external services to which the communications were transmitted, and/or any items of data of the internal executable resource data for the plurality of internal executable resources, including, for example, interaction events indicative of electronic interactions detected with respect to the previously generated external service candidate communications (e.g., subsequent to and/or resulting from transmission of the previously generated external service candidate communication), and/or distribution and/or transaction data associated with the previously generated external service candidate communication (e.g., sales and/or downloads subsequent to and/or resulting from transmission of the previously generated external service candidate communication).

The internal executable resource data may comprise and/or refer identifiers representing internal executable resources and/or categories thereof (e.g., assigned to interaction events detected and/or recorded with respect to the internal executable resources and/or categories), including product information, product categories, platform and/or product tags assigned to posts submitted on community question/answer forums, and/or product tags assigned to renderable content associated with internal executable resources such as blog posts, the product tags identifying which of the internal executable resources is described in and/or associated with the renderable content, to list a few examples. The internal executable resource data may include indications of whether search queries were submitted from user computing devices through the renderable content, including tags identifying particular internal executable resources associated with the renderable content through which the search queries were received (e.g., indications of which product pages were search for each search query in addition to any search terms submitted). The internal executable resource data may include indications of interaction with any navigation links within the renderable content. The internal executable resource data may include indications of loading and/or downloading of any whitepapers or other documents associated with the internal executable resources and provided via the renderable content, including indications of which internal executable resources were associated with the loaded and/or downloaded documents. The internal executable resource data may include indications of loading any video content (e.g., webinars) hosted through the renderable content associated with the internal executable resources, including indications of which internal executable resources were associated with the loaded video content. The executable resource management system (e.g., via renderable content servers) may be configured to automatically generate the identifiers and/or tags in connection with detecting and/or recording the interaction events based on existing metadata associated with the renderable content served by the executable resource management system. The executable resource management system may be configured to generate tracking identifiers (e.g., cookies) associated with the client computing devices and/or cause the tracking identifiers to be stored on the client computing devices and/or included in any requests transmitted from the client computing devices to a renderable content server of the executable resource management system.

In the communication corpus metadata and/or the internal executable resource data, particular states detected within or surrounding internal server devices of the executable resource management system and/or client computing devices in communication with the executable resource management system may refer to a computing and/or communication context within which items of data in the respective data set were generated or received. For example, the particular states may be indicated by an identifier of a current user, one or more labels or tags characterizing the computing and/or communication context (e.g., assigned based on predefined classification rules), an identifier of an internal executable resource and/or a currently executing instance of the internal executable resource, identification of currently presented renderable content, identifiers for particular interface elements of the internal executable resource and/or the renderable content through which the item of data was generated or received, and/or an association of a current event within a computing and/or communication session with an event immediately preceding or immediately succeeding the current event, to list a few examples.

The term “interaction event” may refer to a data construct representing an electronic interaction detected with respect to the plurality of internal executable resources, including an electronic interaction between a client computing device and one or more of the plurality of internal executable resources and/or an electronic interaction between a client computing device and a server for presenting renderable content associated with the plurality of internal executable resources. The external service communication server may be configured to detect, capture, and/or record all or selected types of electronic interactions. Electronic interactions represented by the interaction events may include electronic interactions between client computing devices and the plurality of executable resources and/or electronic interactions between the client computing devices and one or more servers of the executable resource management system 105. The interaction events may include selections and/or input detected within locally executing instances and/or components of the plurality of internal executable resources provided by the executable resource management system (e.g., registered and captured via user interfaces provided by the locally executing instances and/or components of the plurality of internal executable resources), selections and/or input detected within renderable content for providing data about the plurality of internal executable resources provided by the executable resource management system (e.g., registered and captured via user interfaces of the renderable content), including interactions between any intervening client computing devices, server devices, user interfaces, graphical user interfaces, and/or locally or remotely executing applications for providing access to the internal executable resources and/or the renderable content.

The executable resource management system and/or components thereof may be configured to detect the electronic interactions and record interaction events representing the detected electronic interactions, the recorded interaction events including metadata describing the electronic interaction, including attributes identifying a user (e.g., a user of an internal executable resource, a user to which renderable content associated with an internal executable resource is presented), a client computing device, and/or an internal executable resource associated with the electronic interaction, attributes characterizing a communication and/or computing context surrounding the electronic interaction (e.g., identifying behaviors or actions represented by the interaction event, identifying communication and/or computing environments where the electronic interaction represented by the interaction event occurred such as within particular internal executable resources or within particular web applications or communication platforms provided as part of the renderable content associated with the internal executable resources), and/or attributes associating the interaction event with a particular instance of time (e.g., timestamp) or a particular point in a sequence of events (e.g., an indicator of preceding and/or succeeding interaction events recorded for the same user).

The interaction events may be associated with touchpoints between a user and an executable resource providing entity associated with the executable resource management system. A touchpoint may refer to any point of contact or interaction between a first entity and one or more additional entities. The touchpoints to which the interaction events may be associated may include product touchpoints or content touchpoints.

The product touchpoints may refer to points of contact or interaction between the user and the executable resource providing entity within instances and/or components of the internal executable resources. Components and/or instances of the internal executable resources and servers of the executable resource management system may be configured to detect electronic interactions (e.g., between client computing devices, components/instances of the internal executable resources, and/or the servers) occurring at each product touchpoint and record interaction events representing the detected electronic interactions, the recorded interaction events including metadata identifying a product touchpoint associated with the interaction events (e.g., a tag identifying an internal executable resource within which the electronic interaction occurred) along with any other metadata.

The content touchpoints may refer to points of contact or interaction between the user and the executable resource providing entity within renderable content (e.g., web content) associated with the internal executable resources. Web applications for presenting the renderable content and/or servers of the executable resource management system may be configured to detect electronic interactions (e.g., between client computing devices and/or the servers) occurring at each content touchpoint and record interaction events representing the detected electronic interactions, the recorded interaction events including metadata identifying a content touchpoint associated with the interaction events (e.g., a tag identifying an internal executable resource associated with the renderable content within which the electronic interaction occurred, a tag identifying a particular type of renderable content within which the electronic interaction occurred, a tag identifying a transaction associated with the electronic interaction) along with any other metadata.

The touchpoints associated with the interaction events, including any product touchpoints and/or any content touchpoints, may be used by the executable resource management system to generate the candidate selection context. For example, the executable resource management system may be configured to record a sequence of interaction events associated with each user, the sequence representing a temporal and/or ordered series of interaction events recorded for the user. The sequence of interaction events may enable tracking of user behavior across a variety of different touchpoints, including progression from initially loading or performing certain operations within a first internal executable resource to subsequently loading or performing certain operations within one or more additional internal executable resources. Other examples may include progression from initially loading a particular type of renderable content (e.g., product tour page, sign-up form) to subsequently completing particular transactions (e.g., purchases, rentals, trials, licenses, subscriptions) and/or progression from initial submission of a particular raw text object from which a candidate element (e.g., text element) is extracted (e.g., search query, user-generated content) to any other subsequent interaction event, to name a few examples. Detectable patterns in the sequences of interaction events may be indicative of various factors used in generating the candidate selection context such as an inferred intent and/or desire of a user associated with the interaction events and/or an inferred relevance of particular internal executable resources to particular users and/or particular text elements originating from those users, to name a few examples. The executable resource management system may be configured to detect such patterns and generate the candidate selection contexts based at least in part on the detected patterns.

The executable resource management system may be configured to include in the internal executable resource data metadata associated with the interaction events, including location data (e.g., geographical location associated with the client computing device) and/or data describing navigation of the client computing devices to the renderable content (e.g., identifiers representing marketing content that caused the client computing devices to navigate to renderable content associated with the internal executable resources).

The term “raw text object” may refer to a data construct representing a discrete item of textual data representing natural language associated with the plurality of internal executable resources. The raw text object may comprise one or more text strings arranged as natural language. The raw text object may be an item of textual web or digital content associated with and/or describing one or more of the plurality of internal executable resources, which may be hosted, stored, and distributed to client computing devices by the executable resource management system or hosted externally and retrieved by the external service communication server in generating the candidate communication corpus. The raw text object may originate from client computing devices and/or may represent user input received by the client computing devices (e.g., via a user interface). The raw text object may be generated based on user input detected by a client computing device for an instance or component of one of the plurality of internal executable resources (e.g., via a graphical user interface presented by the instance or component of the internal executable resource).

The raw text object may be generated based on user input detected by a client computing device for locally and/or remotely executing web applications for providing data about the plurality of internal executable resources (e.g., via a graphical user interface presented by a web content server of the executable resource management system).

The raw text object may represent a search term of a search query submitted by a user via the client computing device through a search interface of an instance or component of one of the plurality of internal executable resources or through a search interface of a web application for presenting data about the plurality of internal executable resources. The raw text object may represent user-generated web content such as, for example, a web page, blog post, forum post, review, and/or social media post. Each of a plurality of raw text objects included in the candidate communication corpus may comprise textual data about the plurality of internal executable resources, textual data generated by client computing entities and received via one or more of the plurality of internal executable resources during interaction between the client computing entities and the internal executable resources, textual data generated by client computing entities and received via one or more servers for presenting renderable content about the plurality of internal executable resources (e.g., web search queries, user-generated content such as forum posts, reviews, questions, feedback, suggestions).

The term “text element” may refer to a data construct representing a candidate element that is an item of textual data associated with, extracted from, and/or representative of one or more raw text objects (e.g., of the candidate communication corpus). The text element may be generated via one or more natural language processing methods based at least in part on one or more raw text objects. The text element may be a concatenation of a number (e.g., one, two, three) of discrete string units (e.g., words), for example, the string units extracted from the raw text object determined to be most significant (e.g., most representative of or indicative of an intended meaning of the raw text object, most commonly occurring in raw text objects of the candidate communication corpus). In one embodiment, the text element may be a keyword, such as a search keyword or any keyword used in a digital marketing domain.

The term “candidate element context” may refer to a data construct representing a contextual meaning of a candidate element (e.g., text element) occurring within one or more raw text objects (e.g., of the candidate communication corpus). The candidate element context may be determined based at least in part on characteristics and/or statistics describing occurrence of the candidate element (and/or or any meaningful units or words thereof) within the one or more raw text objects, for example, relative to other meaningful units or words occurring in the one or more raw text objects. These characteristics and/or statistics may include quantities and/or frequency of occurrences of the candidate elements within the one or more raw text objects and/or positions (e.g., proximity) of the candidate elements (and/or meaningful units or words thereof) with respect to other meaningful units or words occurring in the one or more raw text objects. In some embodiments and/or examples, the candidate element context may represent the contextual meaning of the candidate element and may be generated using at least one of the one or more candidate selection scoring models (e.g., trained on the candidate communication corpus). For example, the model may be configured to translate a given candidate element to a candidate element context representing the contextual meaning of the given candidate element. The model used to translate the given candidate element to the candidate element context may be a natural language processing model (e.g., transformer model), which may be previously trained on a general corpus and fine-tuned (e.g., further trained) based at least in part on the candidate communication corpus (or portions thereof). The candidate element and/or candidate element context may be vectorized or transformed into a vector (e.g., a vector of real numbers) representing the candidate element and/or candidate element context. The resulting vector corresponding to a given candidate element may be used to determine a degree of semantic similarity (e.g., similarity in contextual or intended meanings of the candidate element) between the given candidate element and one or more other candidate elements, for example, by calculating a cosine similarity and/or cosine distance between the given candidate element in the vectorized form and the one or more other candidate elements in the vectorized form.

The term “candidate selection scoring model” may refer to a data construct that describes parameters, hyperparameters, and/or defined operations of a machine learning model that is configured to generate a candidate selection score for an external service candidate communication and/or a candidate element associated with an external service candidate communication. According to various embodiments of the present disclosure, the candidate selection scoring model may be used to generate a candidate selection score for each external service candidate communication of a plurality of external service candidate communications, each of which is associated with a candidate element (e.g., a text element extracted from a raw text object of the candidate communication corpus), a selected one of the plurality of internal executable resources, and/or an external service intended to receive an external service candidate communication.

In some embodiments, a candidate selection scoring model may, for a given candidate element (e.g., text element), internal executable resource, and/or intended external service, perform a predictive inference, such as determining and/or assigning to a candidate element and/or to an external service candidate communication associated with a candidate element a classification label (e.g., representing a communication operation associated with the candidate element and/or external service candidate communication) based at least in part on semantic similarity between a given candidate element and past candidate elements and on classification labels previously assigned to the past candidate elements.

In some embodiments, a candidate selection scoring model may, for a given candidate element (e.g., text element), internal executable resource, and/or intended external service, perform a predictive inference, such as determining contextual meanings of given candidate elements (e.g., generating a candidate element context representing the contextual meaning) based at least in part on occurrences of the given candidate elements in the candidate communication corpus and/or possibly other corpuses on which the model is trained and/or tuned.

In some embodiments, a candidate selection scoring model may, for a given candidate element (e.g., text element), internal executable resource, and/or intended external service, perform a predictive inference, such as determining a likelihood (e.g., determining a probability) that renderable content associated with the internal executable resource and transmitted for presentation within an interface will result in an electronic interaction with the renderable content subsequent to transmission of the external service candidate communication to the external service, based at least in part on features extracted from an input data set. In one example, the candidate selection scoring model may be configured to express the likelihood in terms of a plurality of features extracted from the input data set.

The input data set may be a data construct that describes data (e.g., the candidate communication corpus, including any candidate elements (e.g., text elements) extracted from the candidate communication corpus, communication corpus metadata, and/or internal executable resource data, including any data concerning one or more of the plurality of internal executable resources, any data concerning the plurality of external services) that may be consumed by the candidate selection scoring model in order to generate the candidate selection score (e.g., for an external service candidate communication). In one example, the input data set for a candidate selection scoring model may comprise past and/or newly processed candidate elements (e.g., indicated in portions of the communication corpus metadata and/or the candidate communication corpus). In one example, the input data set for a candidate selection scoring model may be a current or most up-to-date instance (e.g., at the time of generating the candidate selection score) of the candidate communication corpus, communication corpus metadata, and/or internal executable resource data.

The candidate selection scoring model may undergo a training process using a training data set in order to identify features and to determine optimal coefficients representing adjustment or weights to apply with respect to the features in order to produce a target probability reflected in the training data set (e.g., based on positive and/or negative correlations between the extracted features and detected interaction events and other portions of the internal executable resource data indicative of an electronic interaction that the model is configured to target (e.g., electronic interaction with renderable content associated with an internal executable resource, one or more interaction events associated with an internal executable resource resulting in distribution of the internal executable resource to a client computing device). A candidate selection scoring model may comprise a data object created by using machine learning to learn to perform a given function (e.g., a prediction) through training with the training data set. For example, the training process may formulate a mapping function ƒ from input variables x to discrete output variables y. A candidate selection scoring model may be trained to generate a candidate selection score by learning from a training data set associated with the candidate selection scoring model.

The training data set associated with a candidate selection scoring model may be a data construct that describes data (e.g., the candidate communication corpus, including any candidate elements or text elements extracted from the candidate communication corpus, communication corpus metadata, and/or internal executable resource data, including any data concerning one or more of the plurality of internal executable resources, any data concerning external services) that may be consumed by the candidate selection scoring model (e.g., in a training portion of the model). In one example, the training data set may be a current or most up-to-date instance (e.g., at the time of training the candidate selection scoring model) of the candidate communication corpus, communication corpus metadata, and/or internal executable resource data. The training data set may be a past instance of the same data set used to generate the candidate selection score (e.g., the input data set), whereas the input data set may be a current or most up-to-date instance of the same data set used to train the candidate selection scoring model (e.g., the training data set). The training data set may be used to identify features in the training data set and to determine optimal coefficients representing adjustment or weights to apply with respect to the identified features in order to produce a target probability reflected in the training data set based at least in part on positive and/or negative correlations between extracted features of the training data set (e.g., correlations between raw text objects of the candidate communication corpus and detected interaction events and other internal executable resource data indicative of targeted electronic interactions with which the model is concerned). Features analogous to the features identified in the training data set may then be extracted from an input data and used by the model to generate the candidate selection score. The training data set may (e.g., supervised learning via labeled data) or may not (e.g., unsupervised learning via unlabeled data) include classification labels that characterize data in the training data set. As such, the candidate selection scoring model may learn known (e.g., supervised) or unknown (e.g., unsupervised) relationships or patterns from the training data set.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

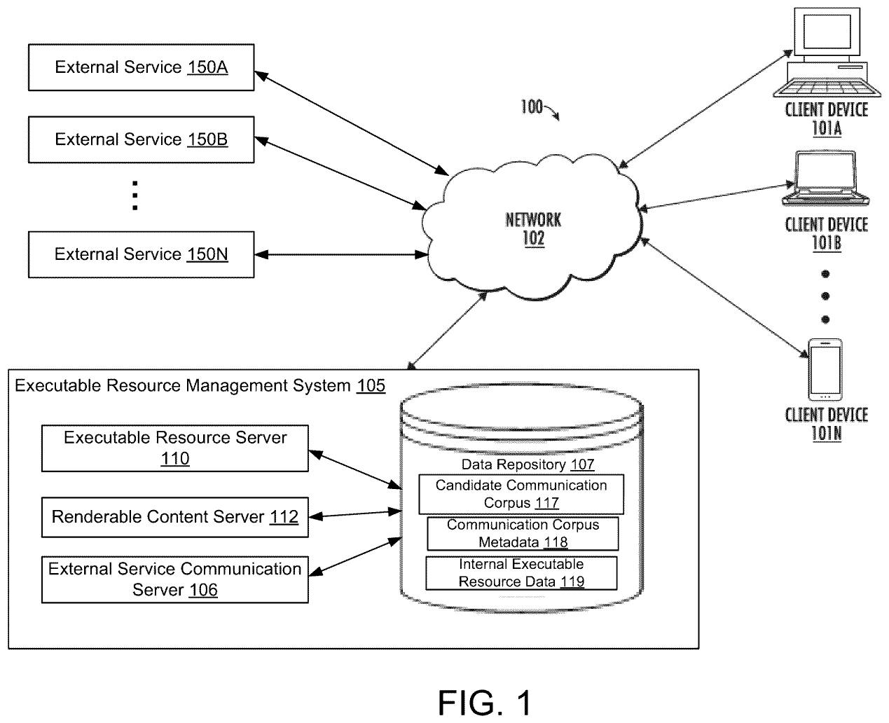

FIG. 1 illustrates an example system architecture 100 within which embodiments of the present disclosure may operate. The system architecture 100 includes an executable resource management system 105 configured to provide access to and/or maintain a plurality of internal executable resources, for example, by interacting with one or more client devices 101A-101N and one or more external services 150A-N in accordance with example embodiments described herein.

The executable resource management system 105 may communicate with the client devices 101A-N and/or external services 150A-150N using a network 102. The network 102 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 102 (e.g., network routers, etc.). For example, the network 102 may include a cellular telephone, an 802.11, 802.16, 802.20, and/or WiMAX network. Further, the network 102 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

The client devices 101A-101N may be any computing device. The client devices 101A-101N may also include circuitry, networked processors, or the like configured to perform some or all of the apparatus-based processes described herein, and may include a suitable network server and/or other type of processing device (e.g., a controller or computing device of the client devices 101A-101N). Electronic data received by the executable resource management system 105 from the client devices 101A-101N may be provided in various forms and via various methods. The depictions in FIG. 1 of “N” client devices are merely for illustration purposes. According to some embodiments, the client devices 101A-101N may be configured to display an interface on a display of the client device for interacting with one or more interface components of the plurality of internal executable resources and/or associated with the plurality of internal executable resources, which may be provided by the executable resource management system 105.

The external services 150A-150N may be any computing device, such as a server, which may be configured to perform the functions of an external service as defined above.

Each of the plurality of internal executable resources may be an executable resource that is maintained by and/or distributed to the client devices 101A-101N by the executable resource management system 105. In one example, an internal executable resource of the plurality of internal executable resources maintained and/or distributed by the executable resource management system 105 may be a software product distributed by an executable resource providing entity (e.g., software technology company) to the client devices 101A-101N via one or more servers or server systems.

In various embodiments, an internal executable resource of the plurality of internal executable resources maintained by the executable resource management system 105 may comprise executable code (e.g., defining software and/or firmware instructions that cause an apparatus or computing device to perform the one or more functions attributed to the particular internal executable resource) specific to the internal executable resource. Each internal executable resource of the executable resource management system 105 may comprise an executable code base specific to the internal executable resource and separate from other internal executable resources of the same executable resource management system 105 (e.g., stored separately from the other internal executable resources, executing independently with respect to the other internal executable resources). In some embodiments, each particular internal executable resource of the executable resource management system 105 may be initiated, operated, and/or interacted with independently with respect to the other internal executable resources of the executable resource management system 105.

The executable resource management system 105 may include one or more data repositories 107. The data repository 107 may store the plurality of internal executable resources, for example, by storing, for each of the plurality of internal executable resources, the executable code and/or software/firmware instructions for causing an apparatus such as a computing device to perform the functionality attributed to the internal executable resource. Each of the plurality of internal executable resources may be stored separately and/or independently with respect to each other, for example, as discrete code bases specific to each internal executable resource. The data repository 107 may store data and/or data about the plurality of internal executable resources, including internal executable resource data 119 and/or data objects representing renderable content (e.g., web content) for providing data about the plurality of executable resources. The data repository 107 may store other data that may be associated with the plurality of internal executable resources, including a candidate communication corpus 117 and communication corpus metadata 118 for the candidate communication corpus 117. The data repository 107 may include one or more storage units, such as multiple distributed storage units that are connected through a computer network. Moreover, each storage unit in the data repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

In the illustrated example, the executable resource management system 105 comprises an executable resource server 110, a renderable content server 112, and an external service communication server 106.

The executable resource server 110 may be configured to provide access by one or more client devices 101A-N to a selected one or more of the plurality of internal executable resources. The executable resource server 110 may provide access to the internal executable resources by sending copies and/or components of the internal executable resources (e.g., in the form of one or more data files containing executable code transmitted over the network 102) to the client devices 101A-101N to execute locally on the client computing devices. The executable resource server 110 may provide access to the internal executable resources by receiving access requests from the client devices 101A-101N, executing, based at least in part on the access requests, the internal executable resources on the executable resource server 110 (e.g., remotely with respect to the client devices 101A-101N), and sending responses to the client devices 101A-101N based on the remote execution of the internal executable resources. The executable resource server 110 may provide access to the internal executable resources via a combination of providing the copies and/or components of the internal executable resources to execute locally on the client devices 101A-101N and providing remote execution of copies, instances, and/or components of the internal executable resources on behalf of the client devices 101A-101N. For example, in order to perform the overall functionality attributed to a particular internal executable resource, the executable resource server 110 may receive access requests by local components of the particular internal executable resource executing on the client devices 101A-101N for remote execution of remote components of the internal executable resources. The executable resource server 110 may provide access to the internal executable resources by controlling access to locally executing and/or remotely executing instances and/or components of the plurality of internal executable resources based at least in part on access permissions, which may be determined independently for each of the plurality of internal executable resources and may be based at least in part on whether client devices 101A-101N attempting to access the locally executing and/or remotely executing instance and/or components of the plurality of internal executable resources are associated with user accounts for which certain transactions with respect to an internal executable resource (e.g., purchases, rentals, trials, licenses, subscriptions) have been completed and/or recorded.

The renderable content server 112 may be configured to provide access by one or more client devices 101A-N to renderable content (e.g., web content) for providing data about the plurality of internal executable resources and/or receiving data (e.g., user-generated content entered via a graphical user interface) associated with the plurality of internal executable resources. For example, the renderable content server 112 may receive a request for renderable content from one of the client devices 101A-101N (e.g., a hypertext transport protocol (HTTP) request), retrieve from the data repository 107 one or more data objects representing the requested renderable content, and transmit the retrieved data objects representing the requested renderable content to the client device, which may present the requested renderable content based upon the transmitted data objects representing the requested renderable content, for example, within an interface of the client device (e.g., a graphical user interface rendered on a display, such as that provided by a web browser or web application). In another example, the renderable content server 112 may receive from one of the client devices 101A-101N, possibly in conjunction with one or more requests for the renderable content, data associated with the plurality of internal executable resources, which data may be received via a graphical user interface rendered on a display of one of the client devices 101A-101N.

The external service communication server 106 may be an external service communication server for managing communication with external services 150A-150N.

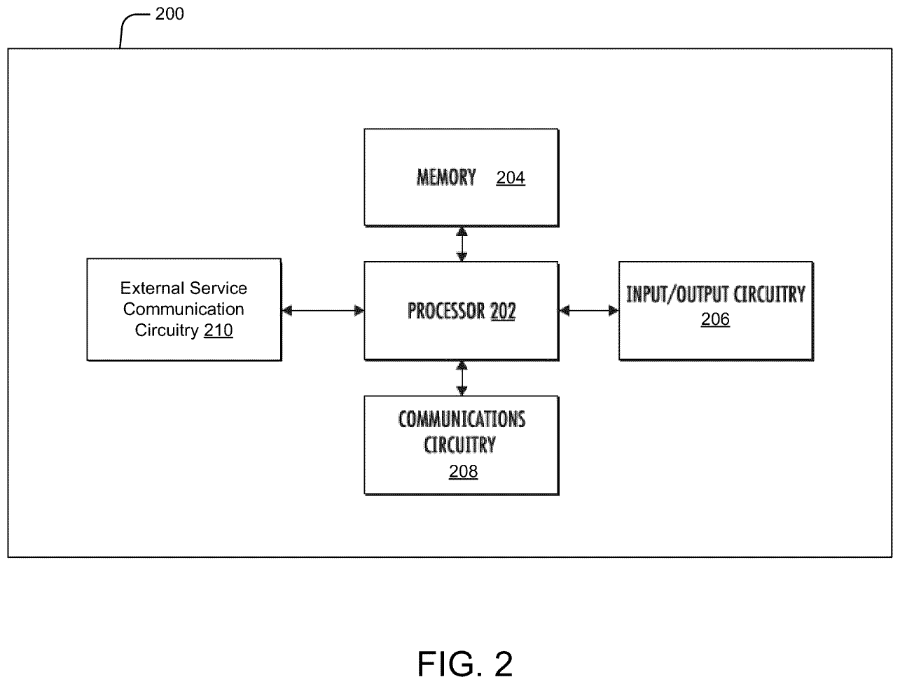

Any of the executable resource server 110, the renderable content server 112, and/or the external service communication server 106 of the executable resource management system 105 may be embodied by one or more computing systems, such as apparatus 200 shown in FIG. 2. The apparatus 200 may include processor 202, memory 204, input/output circuitry 206, communications circuitry 208, and external service communication circuitry 210. The apparatus 200 may be configured to execute the operations described herein. Although these components 202-210 are described with respect to functional limitations, it should be understood that the particular implementations necessarily include the use of particular hardware. It should also be understood that certain of these components 202-210 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing data among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In some embodiments, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

The external service communication circuitry 210 may be any means such as a device or circuitry embodied in either hardware or a combination of hardware and software that is configured to manage communication with the external services 150A-150N.

Similarly, the apparatus 200 may comprise executable resource circuitry and/or renderable content circuitry, which may be any means such as a device or circuitry embodied in either hardware or a combination of hardware and software that is configured to, respectively, provide access to the plurality of internal executable resources or provide renderable content with respect to the plurality of internal executable resources.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

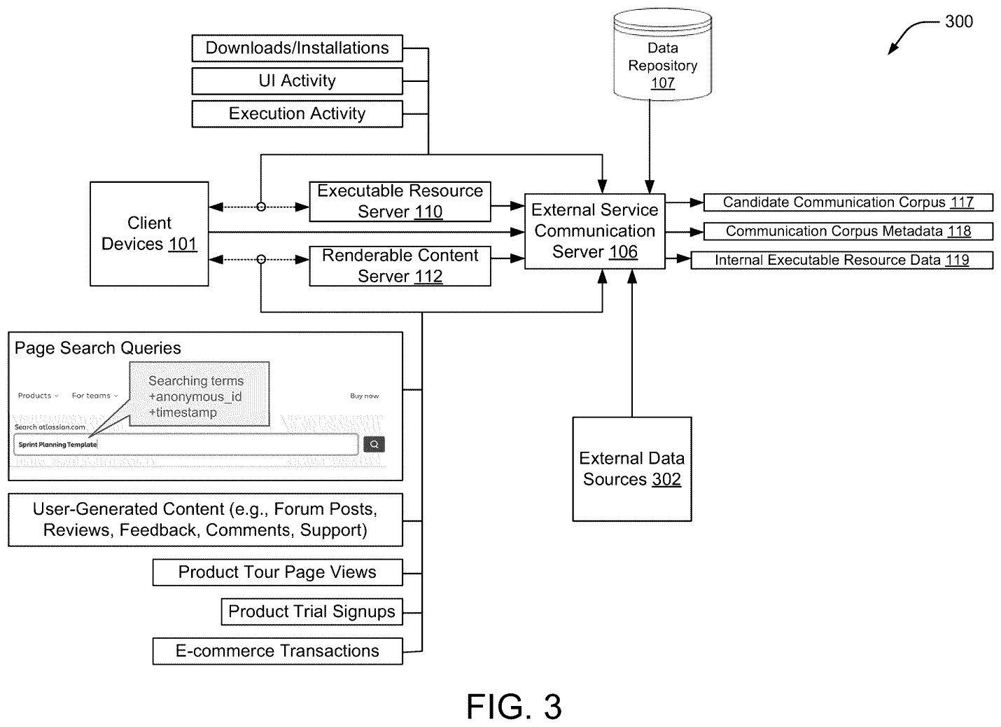

FIG. 3 is a dataflow diagram illustrating an example process 300 for receiving, generating, maintaining, updating, and/or storing data used to generate communications to be transmitted to the external services 150A-150N. The process 300 is illustrated with respect to schematic depictions of various components of the executable resource management system 105 including the external service communication server 106, the executable resource server 110, the renderable content server 112, and the data repository 107, various entities in communication with the executable resource management system 105 including the client devices 101A-101N and one or more external data sources 302, and various data objects.

In the process 300, the external service communication server 106 receives data from various sources (e.g., client devices 101A-101N, executable resource server 110, renderable content server 112, data repository 107, external data sources 302) and outputs the candidate communication corpus 117, the communication corpus metadata 118, and the internal executable resource data 119 based at least in part on the data received from the various sources.

The executable resource management system 105 (e.g., via the external service communication server 106, the executable resource server 110, and/or the renderable content server 112) may be configured to detect, capture, collect, aggregate, request, receive, and/or retrieve from the various sources data concerning the plurality of internal executable resources managed by the executable resource management system 105. More particularly, the external service communication server 106 may be configured to receive data generated by the executable resource server 110, the renderable content server 112, and/or any components of the executable resource management system 105 executing on the client devices 101A-101N during normal operation of the executable resource management system 105. In one example, the external service communication server 106 may be configured to request certain data from the executable resource server 110, the renderable content server 112, and/or the components of the executable resource management system 105 executing on the client devices 101A-101N, for example, on a periodic basis. In another example, the executable resource server 110, the renderable content server 112, and/or the components of the executable resource management system 105 executing on the client devices 101A-101N may be configured to transmit certain data to the external service communication server 106, for example, on a periodic basis or in response to detecting certain events. In another example, the external service communication server 106 may be configured to retrieve certain data previously generated by the various components of the executable resource management system 105 and stored in the data repository 107 (e.g., over time as a historical archive).

The data received from the various sources may comprise interaction events.

The interaction events included in the data received from the various sources may represent electronic interactions between the client devices 101A-101N and the plurality of executable resources may include interactions between the client devices 101A-101N and locally stored copies, locally executing instances, and/or locally stored or executing components of the plurality of internal executable resources, such as, for example, installation or uninstallation of a local copy, instance, or component of an internal executable resource, initialization or termination of a locally executing instance and/or component of an internal executable resource, execution events representing operations performed by locally executing instances and/or components of an internal executable resource, including any operations representing and/or resulting from detected input received via a user interface provided by the locally executing instances and/or components of the internal executable resource. In some embodiments, the locally executing instances and/or components of the plurality of internal executable resources may be configured to register and/or detect such electronic interactions, generate the interaction events based at least in part on the registered and/or detected electronic interactions (e.g., including assigning context-specific metadata to the interaction events indicating details such as timestamps, user identifiers, client device identifiers, locally executing instance and/or component identifiers, tags identifying and/or characterizing the electronic interactions, and/or any data received via a user interface in association with the interaction events), and transmit the interaction events to the executable resource management system 105 (e.g., to the executable resource server 110 and/or directly to the external service communication server 106), which may store the interaction events in the data repository 107 in their original form and/or as portions of the candidate communication corpus 117, the communication corpus metadata 118, and/or the internal executable resource data 119.

The interaction events included in the data received from the various sources may represent electronic interactions between the client devices 101A-101N and the executable resource server 110 may include requests for downloading copies and/or components of one or more of the plurality of internal executable resources, downloads resulting from the download requests, activations and/or validations of downloaded copies and/or components of one or more of the plurality of internal executable resources, validation of any locally executing instances and/or components of the plurality of internal executable resources (e.g., against access permissions stored for each internal executable resource), any interactions between locally executing instances and/or components of the plurality of internal executable resources and the executable resource server 110, including communication between remotely executing and locally executing instances and/or components of the plurality of internal executable resources, requests to access remotely executing instances and/or components of the plurality of internal executable resources (e.g., executing on the executable resource server 110 and/or other servers of the executable resource management system 105) and/or any operations performed by the remotely executing instances and/or components of the plurality of internal executable resources resulting from said access requests.

Additionally, the interaction events included in the data received from the various sources may represent electronic interactions between the client devices 101A-101N and the executable resource server 110 may include transmission by the client devices 101A-101N of any of the interaction events generated by the locally executing instances and/or components of the plurality of internal executable resources to the executable resource server 110. The executable resource server 110 may be configured to register and/or detect such electronic interactions, generate the interaction events based at least in part on the registered and/or detected electronic interactions (e.g., including assigning context-specific metadata to the interaction events indicating details such as timestamps, user identifiers, client device identifiers, locally executing instance and/or component identifiers, remotely executing instance and/or component identifiers, tags identifying and/or characterizing the electronic interactions, and/or any data received via a user interface in association with the interaction events), and transmit the interaction events to other components of the executable resource management system 105 (e.g., external service communication server 106) and/or store the interaction events in the data repository 107.

In the illustrated example, the electronic interactions between the client devices 101A-101N and the executable resource server 110 (and/or the plurality of internal executable resources) include downloads and/or installations of one or more of the plurality of internal executable resources, user interface activity detected within locally and/or remotely executing instances and/or components of the plurality of internal executable resources, and/or execution activity of the locally and/or remotely executing instances and/or components of the plurality of internal executable resources.

The electronic interactions between the client devices 101A-101N and the renderable content server 112 may include requests for renderable content from one of the client devices 101A-101N (e.g., hypertext transport protocol (HTTP) requests), transactions initiated and/or completed via the renderable content with respect to one or more of the plurality of internal executable resources (e.g., purchases, rentals, trials, licenses, subscriptions), execution events representing operations performed by locally executing applications or processes for presenting the renderable content (e.g., web browsers, mobile apps, embedded scripts of the renderable content), including any operations representing and/or resulting from input detected via a user interface provided as part of or in association with the renderable content, including search queries and/or user-generated content. In some embodiments, the renderable content server 112 may be configured to register and/or detect such electronic interactions, generate the interaction events based at least in part on the registered and/or detected electronic interactions (e.g., including assigning context-specific metadata to the interaction events indicating details such as timestamps, user identifiers, client device identifiers, resource identifiers identifying associated one or more internal executable resources of the plurality of internal executable resources, tags identifying and/or characterizing the electronic interactions, and/or any data received via a user interface in association with the interaction events), and transmit the interaction events to other components of the executable resource management system 105 (e.g., external service communication server 106) and/or store the interaction events in the data repository 107.

In the illustrated example, the electronic interactions between the client devices 101A-101N and the renderable content server 112 include page search queries (e.g., search query parameters received via interface elements within renderable content associated with one or more of the internal executable resources), user-generated content (e.g., forum posts, reviews, feedback, comments, support requests received via interface elements within renderable content associated with one or more of the internal executable resources), web traffic data including quantities of page views of renderable content associated with one or more of the plurality of internal executable resources, other user-provided data indicative of interest in one or more of the internal executable resources (e.g., product trial signups for an internal executable resource received via interface elements within renderable content associated with one or more of the internal executable resources), and e-commerce transactions (e.g., purchases, rentals, trials, licenses, subscriptions) initiated and/or completed in connection with the renderable content associated with one or more of the internal executable resources (e.g., submitted via interface elements within renderable content associated with one or more of the internal executable resources). Exemplary metadata for page search query interaction events is depicted, including an identifier associated with a user or client device 101 (e.g., labeled as “anonymous_id”) and a timestamp indicating when the page search query was submitted (e.g., labeled as “timestamp”). This metadata may refer to, be associated with, and/or be incorporated as part of a raw text object representing the search query parameter (“sprint planning template”) entered via a search bar presented as part of a user interface included within renderable content associated with one or more of the plurality of internal executable resources (e.g., a product information page providing information for an internal executable resource).

The data received by the external service communication server 106 may comprise data associated with one or more of the plurality of internal executable resources from one or more external data sources 302. The external data sources 302 may include servers and/or data repositories external to the executable resource management system 105. The data from the external data sources 302 may comprise collections of candidate elements (e.g., text elements) that may be associated with the plurality of internal executable resources and/or data retrieved from external servers of the external data sources 302 in connection with the candidate elements. In one example, the external data sources 302 may include one or more external keyword generation and/or aggregation services, and the data received from the external data sources 302 may comprise collections of keywords determined (e.g., by the external data sources 302) to be potentially associated with the plurality of internal executable resources. In another example, the external data sources 302 may include an external service (such as a search engine service), and the data received from the external data sources 302 may comprise search engine results returned by the external service in response to submission of one or more keywords, including possibly the keywords provided by the external keyword generation and/or aggregation services and/or any internally generated keywords.

The data from the external data sources 302 may comprise one or more raw text objects containing textual data about executable resources other than the plurality of internal executable resources but associated with the internal executable resources, including that provided by entities external with respect to the executable resource management system but having predefined relationships with a executable resource providing entity associated with the executable resource management system (e.g., competitors, partners), including web content about executable resources that perform similar or analogous functions as one or more of the internal executable resources and/or marketing content associated with and/or provided by the external entities. The external service communication server 106 may be configured to submit one or more candidate elements (e.g., text elements) to an external service and extract the one or more raw text objects containing the textual data about the executable resources other than the plurality of internal executable resources from search engine results returned by the external service in response to submission of the one or more candidate elements. The external service communication server 106 may be configured to request web content from one or more external servers (e.g., via a web address associated with the content) and extract one or more raw text objects containing the textual data about the executable resources other than the plurality of internal executable resources from web content returned by the one or more external servers in response to the request. The external service communication server 106 may be configured to request the web content from the one or more external servers based at least in part on the search engine results (e.g., by extracting from the search engine results one or more web addresses for items included in the results and requesting the web content from the one or more external servers via the extracted one or more web addresses).

The external service communication server 106 may be configured to store the one or more raw text objects extracted from the search engine results and/or the web content requested from external server(s) as part of the candidate communication corpus 117 and to store any metadata associated with the one or more raw text objects (e.g., an indication of the one or more candidate elements submitted in a search, an indication of one or more external entities associated with the raw text objects extracted from the search engine results, an indication of one or more of the plurality of internal executable resources that are associated with the raw text objects, an indication of how many results are reflected in the search engine results and/or listing order of the results) as part of the communication corpus metadata 118.

The external service communication server 106 may be configured to generate, maintain, update, and/or store the candidate communication corpus 117, the communication corpus metadata 118, and/or the internal executable resource data 119 based at least in part on the data from the various sources. In one example, the external service communication server 106 may store the data received from the various sources as portions of an existing candidate communication corpus 117, existing communication corpus metadata 118, and/or existing internal executable resource data 119 (e.g., stored in the data repository 107). In another example, the external service communication server 106 may generate the candidate communication corpus 117, the communication corpus metadata 118, and/or the internal executable resource data 119 based at least in part on the received data from the various sources and store the generated candidate communication corpus 117, communication corpus metadata 118, and/or internal executable resource data 119 in the data repository 107. In another example, the external service communication server 106 may generate new portions of the candidate communication corpus 117, communication corpus metadata 118, and/or internal executable resource data 119 based at least in part on the received data from the various sources and update an existing candidate communication corpus 117, existing communication corpus metadata 118, and/or existing internal executable resource data 119 stored in the data repository 107 with the newly-generated portions.

The candidate communication corpus 117 may comprise a plurality of raw text objects, each of which may be associated with one or more of the plurality of internal executable resources. The candidate communication corpus 117 may comprise and/or may be associated with the communication corpus metadata 118.

Raw text objects of the candidate communication corpus 117 may be generated by the client devices 101A-101N and/or received via one or more of the plurality of internal executable resources during interaction between the client devices 101A-101N and the one or more of the plurality of internal executable resources, including raw text objects representing textual data received via user interfaces of locally and/or remotely executing instances and/or components of the one or more of the plurality of internal executable resources. The raw text objects of the candidate communication corpus may be generated by client devices 101A-101N and/or received via the renderable content presented by the renderable content server 112 during interactions between the client devices 101A-101N and the renderable content server 112, including raw text objects representing textual data received via user interfaces of applications and/or processes for presenting renderable content associated with one or more of the plurality of internal executable resources (e.g., web search queries, user-generated content such as forum posts, reviews, questions, feedback).

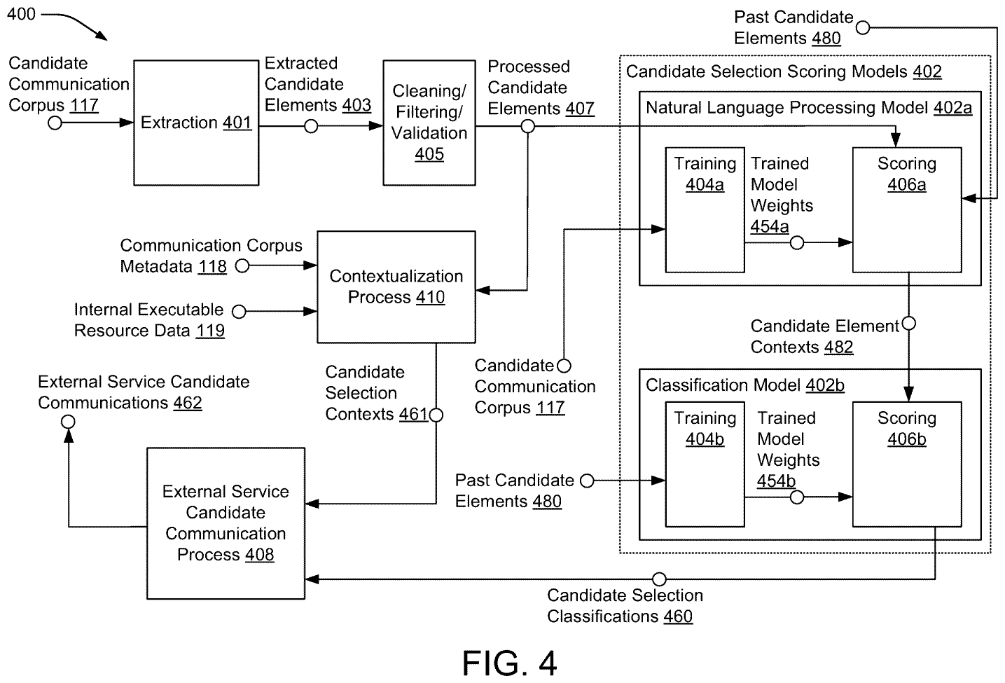

FIG. 4 illustrates an example computing environment for generating candidate selection scores (e.g., including candidate selection classifications) and/or candidate selection contexts for external service candidate communications using one or more candidate selection scoring models and for generating external service candidate communications, in accordance with at least some example embodiments of the present disclosure. In some embodiments, the example computing environments and various data described associated therewith may be maintained by one or more computing devices, such as the external service communication server 106 and/or an apparatus 200 with the external service communication circuitry 210. The external service communication server 106 and/or the apparatus 200, for example, may be specially configured via hardware, software, firmware, and/or a combination thereof, to perform the various data processing and interactions described with respect to FIG. 4 to generate candidate selection scores, candidate selection contexts, and external service candidate communications from the candidate communication corpus 117, the communication corpus metadata 118, and/or the internal executable resource data 119.

In various embodiments, for each of a plurality of external service candidate communications 462, the external service communication server 106 may be configured to generate one or more candidate selection scores such as one or more candidate selection classifications 460 (e.g., using one or more candidate selection scoring models 402), generate one or more candidate selection contexts 461, determine an external service from the plurality of external services 150A-150N to which the given external service candidate communication should be transmitted. The external service communication server 106 may be configured to generate the external service candidate communication 462 based at least in part on the candidate selection score(s) (e.g., candidate selection classifications 460), the candidate selection context(s) 461, and the determined external service to which the external service candidate communication should be transmitted. The external service communication server 106 may be configured to transmit the external service candidate communication to the external service 150. The external service communication server 106 may be configured to generate the candidate selection score(s) (e.g., candidate selection classifications 460), generate the candidate selection context(s) 461, and/or determine the external service 150 to which the given external service candidate communication 462 should be transmitted based at least in part on the candidate communication corpus 117, the communication corpus metadata 118, and/or the internal executable resource data 119.

The example computing environment 400 of FIG. 4 comprises, an extraction process 401, a cleaning/filtering/validation process 405, one or more candidate selection scoring models 402 for generating candidate selection scores (e.g., candidate selection classifications 460), a contextualization process 410 for generating candidate selection contexts 461, and an external service candidate communication process 408 for generating external service candidate communications 462 based at least in part on the candidate selection scores (e.g., candidate selection classifications 460) and the candidate selection contexts 461 generated for the external service candidate communications 462. In an example embodiment, a candidate selection scoring model 402 uses historical data (e.g., past candidate elements associated with previously assigned classification labels in the communication corpus metadata 118) to generate data indicative of a predicted theme, user intent, and/or relevance of a given candidate element with respect to one or more of the plurality of internal executable resources and/or indicative of one or more communication operations to which a plurality of candidate elements, including the given candidate element, are attributed. This data may be used to generate future external service candidate communications 462 and/or may be associated with past and/or future external service candidate communications 462 and stored for future analysis and/or use. In an example embodiment, a candidate selection scoring model 402 uses historical data (e.g., the candidate communication corpus 117, the communication corpus metadata 118, the internal executable resource data 119) to generate data indicative of a predicted relevance of items of data in the candidate communication corpus 117 to one or more of the plurality of internal executable resources and/or indicative of a predicted effectiveness of future external service candidate communications 462 (e.g., as a likelihood that renderable content associated with one of the plurality of internal executable resources and transmitted for presentation within an interface subsequent to transmission of the external service candidate communication 462 will result in an electronic interaction with the renderable content).

The extraction process 401 may receive some or all of the candidate communication corpus 117 as input. More particularly, the extraction process 401 may be configured to ingest a selected one or more raw text objects of the plurality of raw text objects comprised by the candidate communication corpus 117. Based on the input (e.g., the candidate communication corpus 117), the extraction process 401 may be configured to output extracted candidate elements 403, which may be text elements, that have been extracted from the candidate communication corpus 117.

The extraction process 401 may be configured to execute one or more natural language processing algorithms and/or methods for determining, identifying, and/or extracting meaningful phrases from the candidate communication corpus 117.

The extraction process 401 may comprise a tokenization process for breaking a raw text object of the candidate communication corpus 117 into sections representing meaningful units (e.g., words) based on delimiters (e.g., space characters) found within the raw text object.

The extraction process 401 may comprise a lemmatization process for identifying and/or classifying variations in portions of the raw text objects of the candidate communication corpus 117 (e.g., variations in the different meaningful units determined by the tokenization process) that, despite such variations, refer to and/or represent the same concepts. For example, the lemmatization process may be configured to convert the meaningful units of the raw text objects to a standard form representing an intended meaning of the meaningful units common to any variations in how the meaningful units are indicated in the raw text objects. These standard forms may be predefined and/or may be determined and/or defined based at least in part on the candidate communication corpus 117 as part of the extraction process 401.

The extraction process 401 may be configured to generate and/or output the extracted candidate elements 403 (e.g., text elements) based at least in part on the execution of the one or more natural language processing algorithms and/or methods (e.g., tokenization, lemmatization). For example, the extraction process 401 may be configured to generate the extracted candidate elements 403 as one or more sets of tokenized and/or lemmatized meaningful units (e.g., words, phrases) resulting from the tokenization and/or lemmatization processes. The extraction process 401 may be configured to generate an extracted candidate element 403 as a single meaningful unit (e.g., word), a concatenation of a number (e.g., two, three) of discrete meaningful units (e.g., words) that appear in proximity to each other within a raw text object, or a combination thereof. The extraction process 401 may be configured to generate a first set of unigram extracted candidate elements 403 that each comprise a single meaningful unit (e.g., word) identified within the raw text objects, a second set of bigram extracted candidate elements 403 that each comprise a pair of meaningful units that occur in sequence or in proximity to each other within the raw text objects, and a third set of trigram extracted candidate elements 403 that each comprise three meaningful units that occur in sequence or in proximity to each other within the raw text objects. In some embodiments, the first, second, and third sets may overlap with respect to the meaningful units represented by each of the extracted candidate elements 403 in each set. In other words, the extraction process 401 may be configured to generate the first set comprising all unigram meaningful units occurring in the raw text objects, generate the second set comprising all bigram meaningful units occurring in the raw text objects, generate the third set comprising all trigram meaningful units occurring in sequence in the raw text objects, and output the first, second, and third sets as the extracted candidate elements 403.

The natural language processing algorithms and/or methods for determining, identifying, and/or extracting meaningful phrases from the candidate communication corpus 117 used by the extraction process 401 to generate the extracted candidate elements 403 may include a bidirectional representations from transformers (BERT) process and/or model for determining and extracting the meaningful units.

The extraction process 401 may be configured to apply different processing algorithms to different portions (e.g., raw text objects) of the candidate communication corpus 117, for example, based at least in part on characteristics of the different portions, including, for example, quality of a raw text object and/or reliability of a source of a raw text object. In one example, the extraction process 401 may be configured to apply the tokenization and lemmatization processes to a raw text object of the candidate communication corpus 117 in response to determining that the raw text object is designated as having a relatively low quality and/or in response to determining that the raw text object is designated to have originated from a reliable source (e.g., based on metadata describing the raw text object). In another example, the extraction process 401 may be configured to apply the BERT process and/or model to a raw text object of the candidate communication corpus 117 in response to determining that the raw text object is designated as having a relatively high quality and/or in response to determining that the raw text object is designated to have originated from a reliable source. In another example, the extraction process 401 may be configured to generate extracted candidate elements 403 only from portions of the candidate communication corpus 117 (e.g., by generating and outputting the extracted candidate elements 403 for a raw text object only in response to determining that the raw text object is designated to have originated from a reliable source, by disregarding and/or not generating extracted candidate elements 403 for a raw text object in response to determining that the raw text object is designated to have originated from an unreliable source).

The extraction process 401 may be configured to generate portions of the communication corpus metadata 118. For example, the extraction process 401 may generate portions of the communication corpus metadata 118 associating each extracted candidate element 403 with a raw text object of the candidate communication corpus 117 from which the candidate element was extracted and/or with any other metadata describing the associated raw text object from which the candidate element was extracted. In another example, the extraction process 401 may generate portions of the communication corpus metadata 118 indicating quantities and/or statistics describing a relationship between the extracted candidate elements 403 and candidate communication corpus 117, such as an indication of how many times an extracted candidate element 403 appears across all raw text objects of the candidate communication corpus 117 to name one example.

The cleaning/filtering/validation process 405 may receive some or all of the extracted candidate elements 403 output by the extraction process 401 as input. Based on the input (e.g., the extracted candidate elements 403), the cleaning/filtering/validation process 405 may be configured to output processed candidate elements 407, which may be text elements that have been processed, cleaned, filtered, and/or validated by the cleaning/filtering/validation process 405. The cleaning/filtering/validation process 405 may be configured to generate the processed candidate elements 407 by transforming certain of the extracted candidate elements 403 received as input and including in the processed candidate elements 407 the transformed extracted candidate elements 403. The cleaning/filtering/validation process 405 may be configured to generate the processed candidate elements 407 by filtering the extracted candidate elements 403 according to predefined filtering criteria and including in the processed candidate elements 407 certain of the extracted candidate elements 403 while excluding others of the extracted candidate elements 403 according to the predefined filtering criteria. The cleaning/filtering/validation process 405 may be configured to generate the processed candidate elements 407 through a combination of both transforming and filtering the extracted candidate elements 403.

The cleaning/filtering/validation process 405 may be configured to apply different processing algorithms to different portions of the input received by the process (e.g., different text elements of the extracted candidate elements 403), for example, based at least in part on characteristics of the different portions, including, for example, quality of a raw text object and/or reliability of a source of a raw text object from which the extracted candidate element 403 was extracted and/or which processes were used by the extraction model 401 to generate the extracted candidate element 403. In one example, the cleaning/filtering/validation process 405 may be configured to apply no further processing to any extracted candidate elements 403 that were produced from the BERT process and/or model of the extraction process 401 and to simply output these extracted candidate elements 403 as processed candidate elements 407 (e.g., in response to determining that a raw text object from which an extracted candidate element 403 was extracted is designated as having a relatively high quality, in response to determining that the raw text object is designated to have originated from a reliable source, and/or in response to determining that the extracted candidate element 403 is designated as having been produced via the BERT process and/or model). In another example, the cleaning/filtering/validation process 405 may be configured to apply one or more cleaning, filtering, and/or validation methods to any extracted candidate element 403 that were not produced from the BERT process and/or model of the extraction process 401 (e.g., in response to determining that a raw text object from which the extracted candidate element 403 was extracted is designated as having a relatively low quality, in response to determining that the raw text object is designated to have originated from a reliable source, and/or in response to determining that the extracted candidate element 403 is designated as not having been produced via the BERT process and/or model).

The cleaning/filtering/validation process 405 may be configured to generate the processed candidate elements 407 by executing one or more processes for cleaning, filtering, and/or validating the extracted candidate elements 403.

In some embodiments, the cleaning/filtering/validation process 405 may be configured to apply one or more regular expression (regex) operations with respect to the extracted candidate elements 403, for example, to identify and/or filter for any extracted candidate elements 403 determined to have invalid characters (e.g., characters belonging to a predefined invalid character set, characters not belonging to a predefined valid character set). In one example, the valid characters are defined as including any alphabetic characters (e.g., A-z) and any numeric characters (e.g., 0-9). The cleaning/filtering/validation process 405 may be configured to generate the processed candidate elements 407 by removing any invalid characters from the extracted candidate elements 403 determined to have invalid characters. The cleaning/filtering/validation process 405 may be configured to generate the processed candidate elements 407 by filtering for any extracted candidate elements 403 determined to have invalid characters (e.g., by including in the processed candidate elements 407 only those extracted candidate elements 403 that had only valid characters, by not including in the processed candidate elements 407 any extracted candidate elements 403 that had invalid characters).

In some embodiments, the cleaning/filtering/validation process 405 may be configured to identify and/or filter for any extracted candidate elements 403 determined to contain particular meaningful units (e.g., words) such as those belonging to one or more predefined selection sets. The one or more predefined selection sets may be sets of meaningful units (e.g., words), each set being associated with one or more characteristics shared by the meaningful units belonging to the set. The cleaning/filtering/validation process 405 may be configured to process extracted candidate elements 403 containing meaningful units in the one or more predefined selection sets in different ways by performing different actions based at least in part on the particular predefined selection set (e.g., according to processing parameters associated with each particular predefined selection set defining the actions to be taken for extracted candidate elements 403 determined to contain meaningful units included in the particular predefined selection set). These different actions may include removing from the extracted candidate elements 403 any meaningful units (e.g., words) indicated in certain predefined selection sets and/or filtering for any extracted candidate elements 403 determined to have meaningful units (e.g., words) indicated in certain predefined selection sets (e.g., by including in the processed candidate elements 407 only those extracted candidate elements 403 that had only meaningful units not indicated in certain predefined selection sets, by not including in the processed candidate elements 407 any extracted candidate elements 403 that had any meaningful units indicated in certain predefined selection sets).

In various embodiments, a predefined selection set may represent a set of meaningful units (e.g., words) defined by an executable resource providing entity to which the executable resource management system 105 belongs as violating and/or undermining a defined set of values and/or principles of the executable resource providing entity, a set of meaningful units (e.g., words) defined as being insignificant in a natural language processing context and/or an external service candidate communication context (e.g., stop words), a set of meaningful units (e.g., words) defined as being those for which renderable content associated the plurality of internal executable resources should not be presented (e.g., negative keywords), a set of meaningful units (e.g., words) defined as being associated with certain undesirable contexts (e.g., spam-related words, words related to certain themes such as not-safe-for-work themes, words related associated with hate speech), and/or a set of meaningful units (e.g., words) defined as having any other characteristics and/or being associated with any other contexts associated with a natural language processing context and/or an external service candidate communication context.

In some embodiments, the cleaning/filtering/validation process 405 may be configured to identify and/or filter for any extracted candidate elements 403 determined to contain meaningful units (e.g., words) having certain characteristics such as numbers of characters within or outside of certain ranges. For example, the cleaning/filtering/validation process 405 may be configured to identify and/or filter for any extracted candidate elements 403 determined to contain meaningful units (e.g., words) having a number of characters that is below a predetermined minimum character threshold (e.g., two characters) or above a predetermined maximum character threshold (e.g., twenty characters). The cleaning/filtering/validation process 405 may be configured to generate the processed candidate elements 407 by removing from the extracted candidate elements 403 any meaningful units (e.g., words) having a number of characters below the minimum character threshold or above the maximum character threshold and including in the processed candidate elements 407 the resulting transformed candidate elements. The cleaning/filtering/validation process 405 may be configured to generate the processed candidate elements 407 by filtering the extracted candidate elements 403 for any meaningful units (e.g., words) having a number of characters below the minimum character threshold or above the maximum character threshold and including in the processed candidate elements 407 only the extracted candidate elements 403 that were not determined to have meaningful units (e.g., words) with a number of characters below the minimum character threshold or above the maximum character threshold while excluding from the processed candidate elements 407 any extracted candidate elements 403 that were determined to have meaningful units (e.g., words) with a number of characters below the minimum character threshold or above the maximum character threshold.

In some embodiments, the cleaning/filtering/validation process 405 may be configured to generate the processed candidate elements 407 based at last in part on certain metadata (e.g., from the communication corpus metadata 118) describing the extracted candidate elements 403 received as input. The cleaning/filtering/validation process 405 may be configured to generate the processed candidate elements 407 by filtering the extracted candidate elements 403 based at least in part on a number of occurrences of the extracted candidate elements 403 within one or more raw text objects of the candidate communication corpus 117 or across the entirety of the candidate communication corpus 117. For example, the cleaning/filtering/validation process 405 may be configured to generate the processed candidate elements 407 by filtering for any extracted candidate elements 403 having a number of occurrences with respect to the candidate communication corpus 117 (and/or raw text objects thereof) below a minimum occurrence threshold and including in the processed candidate elements 407 only the extracted candidate elements 403 that were determined to have a number of occurrences with respect to the candidate communication corpus 117 above or satisfying the minimum occurrence threshold while excluding from the processed candidate elements 407 any extracted candidate elements 403 that were determined to have a number of occurrences with respect to the candidate communication corpus 117 below the minimum occurrence threshold.

The cleaning/filtering/validation process 405 may be configured to generate the processed candidate elements 407 by standardizing the extracted candidate elements 403 (e.g., converting any meaningful units or words to a predefined standardized form or spelling) and including in the processed candidate elements 407 the standardized extracted candidate elements 403. The predefined standardized forms may include for each meaningful unit (e.g., word) standard spellings and/or fully spelled out phrases corresponding to any shortened or abbreviated forms of the meaningful units (e.g., acronyms).

The cleaning/filtering/validation process 405 may be configured to generate the processed candidate elements 407 by filtering the extracted candidate elements 403 according to a language associated with the extracted candidate elements 403 and including in the processed candidate elements 407 only the extracted candidate elements 403 that are determined to be expressed in a selected language (e.g., English) while excluding any of the extracted candidate elements 403 that are determined not to be expressed in the selected language.

The cleaning/filtering/validation process 405 may be configured to generate the processed candidate elements 407 by performing a deduplication process with respect to the extracted candidate elements 403, including in the processed candidate elements 407 only one iteration of each of the extracted candidate elements 403 while excluding any of the extracted candidate elements 403 that are determined to be duplicates of a candidate element already included in the processed candidate elements 407.

The cleaning/filtering/validation process 405 may be configured to generate the processed candidate elements 407 by filtering the extracted candidate elements 403 based at least in part on search engine results received (e.g., from an external service such as a search engine service) for the extracted candidate elements 403 (e.g., in response to submission of the extracted candidate elements 403 to the external service as part of a search query). In some embodiments, the cleaning/filtering/validation process 405 may be configured to submit each of the extracted candidate elements 403 to the external service and filter the extracted candidate elements 403 based at least in part on the search engine results received in response to the submission. For example, the cleaning/filtering/validation process 405 may be configured to filter the extracted candidate elements 403 based at least in part on whether the search engine results for the extracted candidate elements 403 include and/or refer to renderable content determined to be associated with and/or related to the plurality of internal executable resources.

In one example, the cleaning/filtering/validation process 405 may be configured to include in the processed candidate elements 407 only the candidate elements from the extracted candidate elements 403 for which the search engine results for the candidate elements include and/or refer to renderable content associated with one or more internal executable resources (e.g., corresponding to the renderable content provided via the renderable content server 112), renderable content associated with executable resources that have a predefined relationship with one or more of the plurality of internal executable resources (e.g., resources determined to provide similar or related functionality to one or more of the plurality of internal executable resources, resources determined to be competing software products with respect to one or more of the internal executable resources), and/or renderable content associated with entities that have a predefined relationship with an executable resource providing entity associated with the executable resource management system 105 (e.g., competing entities, partner entities).

In one example, the cleaning/filtering/validation process 405 may be configured to generate metadata (e.g., of the communication corpus metadata 118 based at least in part on the search engine results received for the extracted candidate elements 403, including setting a quality attribute of a candidate element to indicate a relatively high quality (e.g., assigning a high quality label, setting a high quality flag to true) in response to determining that the search engine results received for the candidate element included and/or referred to renderable content associated with one or more internal executable resources, renderable content associated with executable resources that have a predefined relationship with one or more of the plurality of internal executable resources, and/or renderable content associated with entities that have a predefined relationship with an executable resource providing entity associated with the executable resource management system 105.

The processed candidate elements 407 output by the cleaning/filtering/validation process 405 may be input into the one or more candidate selection scoring models 402 and/or the contextualization process 410.

The one or more candidate selection scoring models 402 may be configured to receive the processed candidate elements 407 along with other inputs such as portions and/or iterations of the candidate communication corpus 117, communication corpus metadata 118, and/or the internal executable resource data 119 and generate one or more candidate selection scores (including, for example, one or more candidate selection classifications 460) for each of the processed candidate elements 407 based at least in part on portions of the received inputs associated with the processed candidate element 407 for which the score is being generated.

In the illustrated example, the one or more candidate selection scoring models 402 include a natural language processing model 402a and a classification model 402b. Each of the models 402a, 402b comprises a training portion 404 and a scoring (e.g., inference or prediction) portion 406. More particularly, the natural language processing model 402a comprises a training portion 404a and a scoring portion 406a, and the classification model 402b comprises a training portion 404b and a scoring portion 406b.

In various embodiments, the one or more candidate selection scoring models 402 may undergo a training process (e.g., represented by the training portion(s) 404) using a training data set in order to identify features and to determine optimal coefficients representing adjustment or weights to apply with respect to the features in order to produce a target value (e.g., classification label, probability) reflected in the training data set and/or to otherwise reflect detectable features and/or trends within the training data set. In one example, the training process for a candidate selection scoring model 402 may train the model based on positive and/or negative correlations between the extracted features from the training data set, including detected interaction events and other portions of the internal executable resource data 119 indicative of an electronic interaction that the model is configured to target (e.g., an electronic interaction with renderable content associated with an internal executable resource, one or more interaction events associated with an internal executable resource and resulting in distribution of the internal executable resource to a client device 101). The candidate selection scoring model 402 may comprise a data object created by using machine learning to learn to perform a given function (e.g., a prediction) through training with the training data set. For example, the training process may formulate a mapping function ƒ from input variables x to discrete output variables y. The candidate selection scoring model 402 may be trained to generate a candidate selection score by learning from the training data set.

In one example, the training process 404 may formulate a mapping function ƒ from input variables x to discrete output variables y, with the input variables x each representing features extracted from the training data set. For example, based at least in part on the training process 404, the candidate selection scoring model 402 may be configured to express a candidate selection score for a given processed candidate element 407 using a function ƒ(x₁, x₂, . . . , xₚ), where x₁, x₂, . . . , xₚ are features, quantities, values, and/or metrics extracted, calculated, and/or determined from the training data set with respect to the given processed candidate element 407. In particular, the features, quantities, values, and/or metrics extracted, calculated, and/or determined from the training data set may represent and/or correspond to traits and/or characteristics reflected in the training data set with respect to a particular data item associated with the score and/or communication being generated such as a candidate element extracted from a raw text object of the candidate communication corpus 117 (e.g., the given processed candidate element 407), a selected one of the plurality of internal executable resources, and/or an external service 150 intended to receive an external service candidate communication 462. The features, quantities, values, and/or metrics extracted, calculated, and/or determined from the training data set may be selected and/or arranged to represent certain qualities and/or aspects of the particular data item associated with the score and/or communication being generated, including, for example, relevance (e.g., of a candidate element to one or more of the internal executable resources), profitability (e.g., resulting from external service candidate communications including and/or associated with a candidate element), competitor activity evident from renderable content retrieved from external data sources 302 (e.g., search engine results returned by an external service in response to submission of one or more candidate elements), and/or external feedback (e.g., any data from external data sources 302 concerning a candidate element).

In one example, features, quantities, values, and/or metrics extracted, calculated, and/or determined from the training data set as representative of relevance may include a term-frequency-inverse document frequency (tf-idf) statistic indicating an importance of a candidate element (e.g., text element) across the entire candidate communication corpus 117 or a selected portion of the candidate communication corpus 117, a count or quantity of occurrences of a candidate element within selected portions of the candidate communication corpus 117 associated with each internal executable resource of the plurality of internal executable resources, a count or quantity of occurrences of a candidate element within the entire candidate communication corpus 117, and/or a count or quantity of occurrences of a candidate element being associated with a particular type of interaction event, such as loading of renderable content for providing a product tour for one of the internal executable resources (e.g., the loading of the renderable content for particular users or client devices 101A-101N occurring in connection with interaction events for the same users or client devices 101A-101N involving the candidate element, such as a search of the candidate element).

In another example, features, quantities, values, and/or metrics extracted, calculated, and/or determined from the training data set as representative of profitability may include counts or quantities of occurrences of a candidate element being associated with particular types of interaction events, such as loading of renderable content for providing a product tour for one of the internal executable resources, loading of renderable content for providing a sign-up page for initiating a trial of one of the internal executable resources, loading of renderable content for providing an interface for completing one or more transactions (e.g., purchases). In some embodiments, the features, quantities, values, and/or metrics may also comprise metadata and/or various attributes associated with the particular types of interaction events, including an indication of which version (e.g., page) of the renderable content for providing the product tour was loaded, times at which the renderable content was loaded, durations of presentation of the renderable content, a count and/or quantity of page loads occurring before the particular types of interaction events, and/or an indication of which transactions were completed and which of the internal executable resources were the subject of the transactions, to list a few examples. Moreover, the features, quantities, values, and/or metrics extracted, calculated, and/or determined from the training data set as representative of profitability may include a projected value associated with a particular candidate element based at least in part on the profitability-related features, quantities, values, and/or metrics associated with a candidate element that is semantically similar to the particular candidate element.

In another example, features, quantities, values, and/or metrics extracted, calculated, and/or determined from the training data set as representative of competitor activity evident from renderable content retrieved from external data sources 302 include depth of search engine results returned by an external service in response to submission of a candidate element and/or a number of competitors (e.g., competing executable resource providing entities) reflected in the search engine results, to list a few examples.

In another example, features, quantities, values, and/or metrics extracted, calculated, and/or determined from the training data set as representative of external feedback for a candidate element include a value indicative of spending by competing executable resource providing entities associated with the candidate element, a value indicative of a cost (e.g., average cost, total cost) associated with generating and/or driving web traffic associated with a candidate element, a cost-per-click (CPC) or value indicative of a cost associated with a candidate element (e.g., per electronic interaction associated with the candidate element), and/or an indication of recency of activities associated with the candidate element of competing executable resource providing entities, to list a few examples.

In some embodiments, the training data set(s) are input into the training portion(s) 404 of the one or more candidate selection scoring models 402 to train the model(s) to generate one or more candidate selection scores. A product of the model training may be trained model weights 454 that are used by the scoring (e.g., inference or prediction) portion(s) 406 of the candidate selection scoring model(s) 402. In some embodiments, after an initial training, further training data may be input to the training portion(s) 404 of the candidate selection scoring model(s) 402, periodically or on an on-going basis, to refine and update the model.

The one or more candidate selection scoring models 402 may be trained to generate one or more candidate selection scores based at least in part on an input data set. The candidate selection scoring model(s) 402 may be configured to receive the processed candidate elements 407 and generate a candidate selection score 460 for each candidate element of the processed candidate elements 407 based at least in part on portions of the input data set that are associated with the candidate element for which the score is being generated.

In some embodiments, an input data set for generating the candidate selection scores may comprise a future candidate communication corpus, future communication corpus metadata, and future internal executable resource data, each of which represent instances of, respectively, the candidate communication corpus 117, the communication corpus metadata 118, and the internal executable resource data 119 at an instance of time corresponding to the scoring portion 406 (e.g., an instance of time when the candidate selection scoring model 402 is used to generate candidate selection scores for external service candidate communications). The instance of time corresponding to the scoring portion 406 may be a “future” instance of time relative to a previous instance of time when the candidate selection scoring model 402 is trained. Accordingly, each of the future candidate communication corpus, future communication corpus metadata, and future internal executable resource data may represent a version of, respectively, the candidate communication corpus 117, the communication corpus metadata 118, and the internal executable resource data 119 that is available at the instance of time corresponding to the scoring portion 406, including the most updated version available at the time that each score is generated.

In the illustrated example, the training data set input into the natural language processing model 402a of the one or more candidate selection scoring models 402 at the training portion 404a comprises some or all of the data included in the candidate communication corpus 117 at an instance of time corresponding to the training portion 404a (e.g., an instance of time when the natural language processing model 402a is trained). The input data set input into the natural language processing model 402a at the scoring portion 406a comprises the processed candidate elements 407 output by the cleaning/filtering/validation process 405 and past candidate elements 480. The past candidate elements 480 may comprise candidate elements that are already known by the executable resource management system 105 such as one for which one or more external service candidate communications 462 have been previously generated. The natural language processing model 402a may be a transformer model and may be previously trained on a general corpus and fine-tuned (e.g., further trained) based at least in part on the candidate communication corpus 117 (or portions thereof) during the training portion 404a. The training process 404a may generate trained model weights 454a based at least in part on the candidate communication corpus 117, which, when input into the scoring portion 406a, may cause the scoring portion 406a to generate one or more candidate element contexts 482 representing contextual meanings of, respectively, the processed candidate elements 407 and the past candidate elements 480 with respect to the general corpus and the candidate communication corpus 117 used to fine-tune the model. The scoring portion 406a may also be configured to vectorize the candidate elements, including the processed candidate elements 407 and/or the past candidate elements 480, and the candidate element contexts 482 may be output in a vectorized form (e.g., as vectors of real numbers representing the candidate elements and/or the contextual meanings thereof).

The training data set input into the classification model 402b of the one or more candidate selection scoring models 402 at the training portion 404b comprises the past candidate elements 480, such as those input into the scoring portion 406a of the natural language processing model 402a. The training data set input into the classification model 402b at the scoring portion 406b comprises the candidate element contexts 482 output by the scoring portion 406a of the natural language processing model 402a. The classification model 402b may be a trained during the training portion 404b based at least in part on the past candidate elements 480, including, for example, classification labels associated with each of the past candidate elements 480 (e.g., in the communication corpus metadata 118 and/or the internal executable resource data 119). The training process 404b may generate trained model weights 454b based at least in part on the past candidate elements 480 (e.g., the previously assigned classification labels associated with each of the past candidate elements 480), which, when input into the scoring portion 406b, may cause the scoring portion 406b to generate one or more candidate selection scores in the form of candidate selection classifications 460 representing classification labels assigned to the processed candidate elements 407 based on, for example, semantic similarities between the processed candidate elements 407 and one or more of the past candidate elements 480.

In some embodiments, the scoring portion 406b of the classification model 402 of the one or more candidate selection models 402 may be configured to generate a candidate selection score representing specifically a candidate selection classification 460 based at least in part on semantic similarities between a processed candidate element 407 associated with the candidate selection classification 460 and one or more previously classified past candidate elements 480. The scoring portion 406b generate the candidate selection classification 460 based at least in part on the candidate element context 482 corresponding to the processed candidate element 407 and the candidate element contexts 482 corresponding to the one or more previously classified past candidate elements 480. The semantic similarities between the processed candidate element 407 associated with the candidate selection classification 460 and the one or more previously classified candidate elements 480 may be determined based at least in part on the candidate element contexts 482 received from the natural language processing model 402a, which may be trained on the candidate communication corpus 117. The scoring portion 406b may be configured to determine the semantic similarities between the processed candidate element 407 associated with candidate selection classification 460 based at least in part on vectorizing the processed candidate element 407 and the one or more previously classified past candidate elements 480, which vectorization may be performed using the natural language processing model 402a or as part of the scoring portion 406b of the classification model 402b. The scoring portion 406b may be configured to generate the candidate selection classifications 460 by determining the semantic similarities between the processed candidate element 407 associated with the candidate selection classification 460 and the one or more previously classified past candidate elements 480, for example, by calculating a cosine similarity between a candidate element context 482 of the processed candidate element 407 and one or more candidate element contexts 482 of the one or more previously classified past candidate elements 480. The scoring portion 406b may be configured to generate the candidate selection classification 460 by selecting a previously classified past candidate element 480 of the one or more previously classified past candidate elements 480, such as that having a degree of semantic similarity with the processed candidate element 407 that is highest among the one or more previously classified past candidate elements 480. The scoring portion 406b may be configured to assign a classification label to the processed candidate element 407 matching a classification label associated with the selected previously classified past candidate element 480. Additionally, the scoring portion 406b may be configured to assign a classification label indicating creation of a new classification category to the processed candidate element 407 in response to determining that none of the one or more previously classified past candidate elements 480 has a degree of semantic similarity with the processed candidate element 407 that satisfies a predetermined similarity threshold.

In one example, the scoring portion 406b may be configured to assign a classification label to each of the processed candidate elements 407, the classification label classifying the processed candidate element 407 as being associated with and/or a member of a category represented by a selected past candidate element of the past candidate elements 480, for example, in response to determining that a calculated cosine similarity between the candidate element context 482 of the processed candidate element 407 and the candidate element context 482 of the selected past candidate element indicates that the processed candidate element 407 is most similar to the selected past candidate element relative to the similarity between the processed candidate element 407 and any other past candidate elements of the past candidate elements 480. In some embodiments, the scoring portion 406b may be configured to assign the classification label from a selected past candidate element to the processed candidate element 407 only in response to determining that the calculated cosine similarity between the candidate element context of the processed candidate element 407 and that of the selected past candidate element is within a predetermined similarity threshold. In some embodiments, in response to determining that the calculated cosine similarity between the candidate element context 482 of the processed candidate element 407 and that of any of the past candidate elements 480 is not within the predetermined similarity threshold, the scoring portion 406b may be configured to generate and/or assign a tag indicating that a new category should be created. In response to assigning of the tag indicating the new category, the external service communication server 106 may generate and/or transmit (e.g., to one or more client devices 101A-101n) a notification indicating that a new category should be and/or has been created, and/or to generate the new category and assign the processed candidate element 407 to the newly created category.

In some embodiments, a future candidate communication corpus, future communication corpus metadata, and future internal executable resource data may be input into a scoring portion 406 of a candidate selection scoring model of the one or more candidate selection scoring models 402. Upon receiving the future candidate communication corpus, future communication corpus metadata, and future internal executable resource data, the scoring portion 406 may be configured to output candidate selection scores, for example, representing a programmatically generated likelihood that renderable content (e.g., identified/retrieved via one or more renderable content identifiers of an external service candidate communication) associated with an internal executable resource and transmitted for presentation within an interface will result in an electronic interaction with the renderable content subsequent to transmission of the external service candidate communication to the external service. Each candidate selection score may be associated with a candidate element (e.g., text element) extracted from one or more raw text objects of the candidate communication corpus 117, such as one of the processed candidate elements 407. In some embodiments, the candidate selection score may be generated (e.g., via the scoring portion 406 of the candidate selection scoring model 402) based at least in part on portions of the communication corpus metadata 118 associating the one or more raw text objects (from which the associated candidate element was extracted) with one or more of the plurality of internal executable resources. The candidate selection score may be generated (e.g., via the scoring portion 406 of the candidate selection scoring model 402) based at least in part on portions of the internal executable resource data 119 and/or communication corpus metadata 118 associating raw text objects of the candidate communication corpus 117 (e.g., the raw text objects from which candidate elements associated with the score were extracted) with one or more interaction events (e.g., indicated in the communication corpus metadata 118 and/or the internal executable resource data 119).

The candidate selection classifications 460 (e.g., of the candidate selection scores generated via the one or more candidate selection scoring models 402) output by the classification model 402b may be input into the external service candidate communication process 408 along with candidate selection contexts 461 generated by the contextualization process 410 in connection with each of processed candidate elements 407.

The contextualization process 410 may be configured to receive the processed candidate elements 407 along with other inputs such as portions and/or iterations of the communication corpus metadata 118 and the internal executable resource data 119 and generate candidate selection contexts 461 for each of the processed candidate elements 407 based at least in part on portions of the communication corpus metadata 118 and/or the internal executable resource data 119 associated with the processed candidate element 407 for which the context is being generated.

In the illustrated example, the contextualization process 410 receives the processed candidate elements 407 output by the cleaning/filtering/validation process 405 and portions and/or iterations of the communication corpus metadata 118 and the internal executable resource data 119 and outputs the candidate selection contexts 461 (e.g., based at least in part on the received).

The candidate selection context 461 may be generated by the contextualization process 410 based at least in part on the candidate communication corpus 117, the communication corpus metadata 118, and/or the internal executable resource data 119. In some embodiments, the candidate selection contexts 461 are generated using one or more machine learning models. A training portion of the one or more machine learning models for generating the candidate selection contexts 461 may receive a training data set comprising the past communication corpus metadata, past internal executable resource data, and/or the past candidate communication corpus and, based on the training data set, generate and/or configure the model(s) (e.g., via trained model weights output by the training portion). A prediction or inference portion of the one or more machine learning models for generating the candidate selection contexts 461 (or any portion analogous to the scoring portion 406 of the candidate selection scoring model 402) may receive an input data set comprising the future communication corpus metadata, future internal executable resource data, and/or the future candidate communication corpus along with the processed candidate elements 407 and, based on the input data set and the trained model weights, generate the candidate selection contexts 461.

In one example, the candidate selection context 461 may be generated (e.g., by the external service communication server 106) based at least in part on portions of the communication corpus metadata 118 associating one or more raw text objects of the candidate communication corpus 117 (e.g., the raw text objects from which candidate elements associated with the context were extracted such as a given processed candidate element 407 for which the context is being generated) with one or more internal executable resources of the plurality of internal executable resources. In another example, the candidate selection context 461 may be generated based at least in part on portions of the internal executable resource data 119 and/or communication corpus metadata 118 associating raw text objects of the candidate communication corpus 117 (e.g., the raw text objects from which candidate elements associated with the context were extracted such as a given processed candidate element 407 for which the context is being generated) with one or more interaction events (e.g., indicated in the communication corpus metadata 118 and/or the internal executable resource data 119).

The candidate selection context 461 may be based at least in part on and/or representative of a predicted relevance of a candidate element (e.g., of the processed candidate elements 407) to an internal executable resource being mapped to the candidate element via the candidate selection context 461. In one example, the candidate element may be a keyword extracted from raw text objects of the candidate communication corpus 117 (e.g., via the extraction process 401 and/or cleaning/filtering/validation process 405), and the candidate selection context 461 may represent a predicted relevance of the keyword to a software product to which the keyword (and/or a score associated with the keyword) is mapped. This predicted relevance may be determined based at least in part on communication corpus metadata 118 linking the raw text objects from which the keyword was extracted to the software product and/or based at least in part on communication corpus metadata 118 linking the raw text objects to certain interaction events, such as detected instances of users downloading, sampling, purchasing, and/or otherwise engaging with the software product or related software products in connection with the keyword (e.g., after entering a search query or submitting user-generated content containing the keyword).

In some embodiments, the candidate selection contexts 461 output by the contextualization process 410 may comprise a set of candidate element and executable resource pairings, each of the pairings specifying a candidate element (e.g., of the processed candidate elements 407) and a selected one of the plurality of internal executable resources being mapped to the candidate element. One or more of the processed candidate elements 407 may be indicated in more than one of the pairings and paired with more than one of the plurality of internal executable resources. One or more of the plurality of internal executable resources may be indicated in more than one of the pairings and paired with more than one of the processed candidate elements 407.

The candidate selection contexts 461 output by the contextualization process 410 and/or the processed candidate elements 407 output by the cleaning/filtering/validation process 405 may be fed into a localization process for generating one or more additional sets of processed candidate elements 407, each of the one or more additional sets being associated with a different language other than a primary language associated with a main set of the processed candidate elements 407 (e.g., English) and comprising candidate elements analogous to those of the processed candidate elements 407 but translated into the associated language.

In some embodiments, the contextualization process 410 may be configured to generate the candidate selection contexts 461 based at least in part on data (e.g., from the communication corpus metadata 118 and/or internal executable resource data 119) describing activity and/or behavior of one or more entities external with respect to the executable resource management system 105 but having predefined relationships with a executable resource providing entity associated with the executable resource management system (e.g., competitor intelligence). For example, the candidate selection contexts 461 for a given candidate element may be generated based at least in part on search engine results received from an external service (such as a search engine service) in response to submission of the given candidate element to the external service as a search query. The contextualization process 410 may be configured to submit each of the processed candidate elements 407 to the external service and generate the candidate selection context 461 for each processed candidate element 407 based at least in part on the search engine results returned in response to submission of the processed candidate element 407. In one example, the contextualization process 410 may be configured to generate a candidate selection context 461 for the processed candidate element 407 mapping the processed candidate element 407 to an internal executable resource in response to determining that the search engine results include renderable content provided by one or more entities external with respect to the executable resource management system 105 but having predefined relationships with a executable resource providing entity associated with the executable resource management system (e.g., competitors) and/or renderable content associated with executable resources analogous to one or more of the internal executable resources but provided by the external entities.

In some embodiments, the contextualization process 410 may be configured to generate the candidate selection contexts 461 based at least in part on semantic similarity between processed candidate elements 407 and previously mapped candidate elements (e.g., past candidate elements 480 for which candidate selection contexts 461 have been previously generated). In one example, the contextualization process 410 may compare a processed candidate element 407 (e.g., newly extracted from the candidate communication corpus 117) to one or more of the previously mapped candidate elements (e.g., by determining a contextual meaning or candidate element context for each candidate element using the natural language processing model 402a, vectorizing the candidate element contexts and/or candidate elements, calculating a cosine similarity between the vectors corresponding to the processed candidate element 407 and each of the one or more of the previously mapped candidate elements, determining whether the cosine similarity satisfies a predetermined similarity threshold). In response to determining that the processed candidate element 407 has a degree of semantic similarity with a particular previously mapped candidate element that is relatively higher than that with respect to any other previously mapped candidate element, the contextualization process 410 may be configured to generate a candidate selection context 461 mapping the processed candidate element 407 with the same internal executable resource(s) as that/those mapped with the particular previously mapped candidate element.

In some embodiments, the candidate selection classifications 460 output by the classification model 402b may represent an association of a processed candidate element 407 with a communication operation. In one example, the communication operation represents a campaign (e.g., marketing campaign) with which one or more of the processed candidate elements 407 and/or external service candidate communications 462 may be associated.

The communication operation may be one of a plurality of communication operations, which may be part of a larger organization structure indicating optimal groupings and/or clusters of the processed candidate elements 407 and any renderable content associated with the processed candidate elements 407 for various different communication objectives to which the external service candidate communications 462 relate. The external service communication server 106 may be configured to generate one or more communication themes (e.g., associated with and/or represented by the communication operations) based at least in part on the processed candidate elements 407 and/or the renderable content associated with the processed candidate elements 407, the communication themes representing and/or being generated based at least in part on a communication intent inferred for each of the processed candidate elements 407 and/or associated renderable content. The external service communication server 106 may be configured to group or cluster portions or instances of the renderable content associated with the processed candidate elements 407 together based at least in part on similarity of the inferred communication intent for the renderable content within each grouping or clustering. The external service communication server 106 may be configured to determine an organization structure for the communication operations and/or communication themes based at least in part on applying one or more predefined organization rules to the processed candidate elements 407 and/or associated renderable content. In one example, the organization structure data includes an assignment to each processed candidate element 407 and/or to each portion and/or instance of the renderable content associated with the processed candidate elements 407 of an anchor and/or one or more sub-anchors. The anchors and/or sub-anchors may be attributes and/or labels, each associated with a different communication intent and/or communication theme. Data and/or metadata describing the organization structure may be input to the external service candidate communication process 408 and/or used to generate the external service candidate communications 462.

In some embodiments, the candidate selection classifications 460 output by the classification model 402b may represent one or more themes, user intent, and/or relevance of the processed candidate element 407 with respect to one or more of the plurality of internal executable resources. The candidate selection classifications 460 may comprise anchors and/or sub-anchors assigned to each of the processed candidate elements 407 and characterizing the one or more themes, user intent, and/or relevance of the processed candidate element 407.

The candidate selection classifications 460 for the processed candidate elements 407 may be further associated with any external service candidate communications 462 generated with respect to the processed text elements 407. The candidate selection classifications 460, the external service candidate communications 462, and/or any metadata indicating the candidate selection classification(s) 460 with respect to the processed text elements 407 and/or the external service candidate communications 462 may be stored (e.g., in the one or more data repositories 107, as part of the internal executable resource data 119 and/or communication corpus metadata 118) for future analysis and/or use.

In various embodiments, the external service candidate communication process 408 may execute on the external service communication server 106 and/or via the external service communication circuitry 210 of the apparatus 200 and may cause the server 106 and/or the apparatus 200 to perform the various functions defined herein with respect to generating the external service candidate communications 462.

According to the external service candidate communication process 408, for each of a plurality of external service candidate communications 462 (e.g., for which candidate selection scores 460 and/or candidate selection contexts 461 were generated), the external service communication server 106 may generate the external service candidate communication 462 based at least in part on one or more candidate selection scores (e.g., the candidate selection classifications 460), one or more candidate selection contexts 461, and the determined external service to which the external service candidate communication 462 should be transmitted.

Each of the external service candidate communications 462 (e.g., generated by the external service communication server 106 via the external service candidate communication process 408) may comprise particular data parameters and/or formatting expected by the external service 150 receiving the external service candidate communication 462.

In one example, the external service candidate communication 462 may comprise one or more renderable content identifiers for requesting renderable content (e.g., from the renderable content server 112 or another content server internal or external to the executable resource management system 105), which may be presented within an interface subsequent to transmission of the external service candidate communication to the external service 150.

In another example, the external service candidate communication 462 may comprise one or more candidate elements (e.g., including any of the processed candidate elements 407 extracted from the candidate communication corpus 117), which may cause the renderable content (e.g., identified via the one or more renderable content identifiers of the external service candidate communication 462) to be presented in certain situations associated with the one or more candidate elements included in the external service candidate communication 462.

In another example, the external service candidate communication 462 may constitute and/or comprise a communication opportunity request representing a request for the renderable content (e.g., identified via the one or more renderable content identifiers of the external service candidate communication 462) to be presented according to a requested transaction associated with the external service candidate communication 462. In some embodiments, the external service candidate communication 462 may comprise various attributes associated with, representing, indicative of, and/or characterizing the requested transaction, including, for example, an exchange value representing an amount of a medium of exchange (e.g., a monetary value) transferred from an entity associated with the executable resource management system 105 to an external entity (e.g., associated with the external service 150) in conjunction with presenting the renderable content identified in the external service candidate communication 462.

In one example, the candidate selection score used to generate an external service candidate communication 462 representing a communication opportunity request (e.g., for presenting sponsored content associated with an internal executable resource) may represent a programmatically generated likelihood that the sponsored content will result in an electronic interaction with the sponsored content (e.g., a selection of one or more elements of the sponsored content to navigate to further renderable content provided by the renderable content server 112). In a similar example concerning sponsored content, the candidate selection score may be associated with a candidate element, namely a keyword extracted from raw text objects of the candidate communication corpus 117 (e.g., a processed candidate element 407), said candidate element being indicative of an intent and/or desire of a user and/or of a targeted communication and/or computing context of a client device 101 associated with a user, in response to detection of which the sponsored content is caused by the external service candidate communication 462 to be presented.

According to the external service candidate communication process 408, the external service communication server 106 may be configured to generate the external service candidate communication 462, including any of its particular data parameters and/or formatting, based at least in part on one or more candidate selection scores (e.g., candidate selection classifications 460) and/or one or more candidate selection contexst 461 generated by the external service communication server 106 for the external service candidate communication 462, and/or based at least in part on the determined external service 150 to which the external service candidate communication 462 should be transmitted. For example, the external service communication server 106 may determine the one or more renderable content identifiers included in the external service candidate communication 462 based at least in part on the candidate selection context 461 generated by the external service communication server 106 for the external service candidate communication 462. In another example, the external service communication server 106 may determine the one or more candidate elements (e.g., including any of the processed candidate elements 407 extracted from raw text objects of the candidate communication corpus 117) included in the external service candidate communication 462 based at least in part on a candidate selection score associated with one or more of the candidate elements. In yet another example, the external service communication server 106 may determine a requested transaction of the external service candidate communication 462 and/or attributes associated with the requested transaction (e.g., the exchange value) based at least in part on the candidate selection scores, including any candidate selection classifications 460, and/or the candidate selection contexts 461 generated for the external service candidate communication 462, and/or the determined external service 150 to which the communication 462 is to be transmitted.

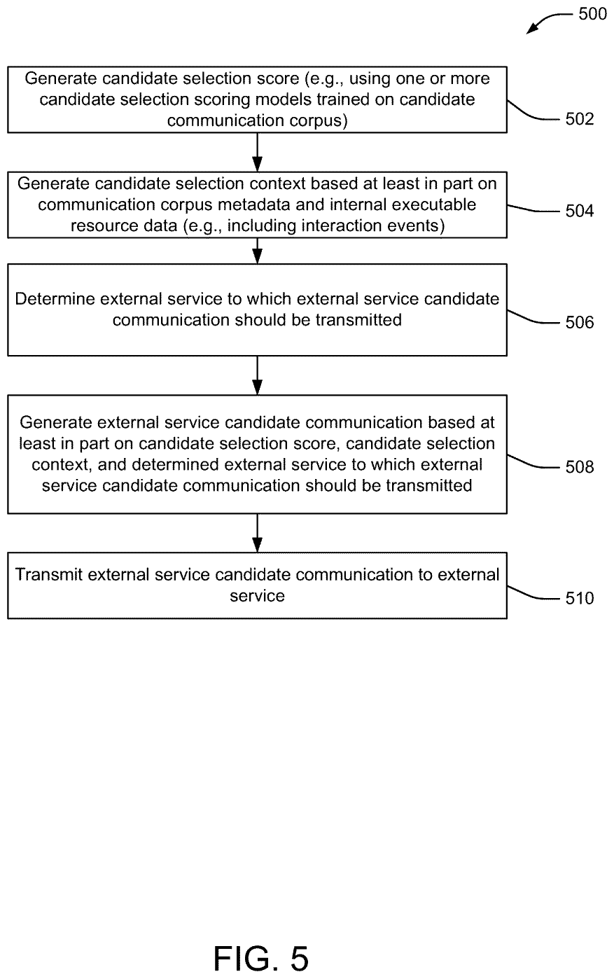

FIG. 5 is a flowchart diagram of an example process 500, for generating and transmitting the external service candidate communication.

The process 500 may be performed (e.g., by the external service communication server 106) for each external service candidate communication 462 of a plurality of external service candidate communications 462.

The process 500 begins at operation 502, where the external service communication server 106 (and/or external service communication circuitry 210 of the apparatus 200) generates one or more candidate selection scores for the external service candidate communication 462. The one or more candidate selection scores generated at operation 502 may include, for example, a candidate selection classification 460.

At operation 504 of the process 500, the external service communication server 106 (and/or external service communication circuitry 210 of the apparatus 200) generates one or more candidate selection context 461 for the external service candidate communication 462 based at least in part on the communication corpus metadata 218 and the internal executable resource data 219, and/or possibly the candidate communication corpus 217. The candidate selection context 461 generated at operation 504 may comprise a mapping of a candidate element (e.g., of the processed candidate elements 407) with an internal executable resource of the plurality of internal executable resources managed by the executable resource management system 105. The internal executable resource data 119 used at operation 504 may comprise interaction events representing electronic interactions detected for client devices 101A-101N with respect to one or more internal executable resources of the plurality of internal executable resources, including electronic interactions detected between the client devices 101A-101N and executing instances of the one or more internal executable resources and/or electronic interactions detected between the client devices 101A-101N and renderable content associated with the one or more internal executable resources.

In one example, the external service candidate communication may be associated with a candidate element extracted from one or more raw text objects of the candidate communication corpus 117, and the candidate selection context 461 may be generated at operation 504 based at least in part on portions of the communication corpus metadata 118 associating the one or more raw text objects with one or more internal executable resources of the plurality of internal executable resources managed by the executable resource management system 105. In another example, the candidate selection context 461 generated at operation 504 may be generated based at least in part on portions of the communication corpus metadata 118 (and/or the internal executable resource data 119) associating raw text objects of the candidate communication corpus 117 (e.g., from which a candidate element associated with the score was extracted) to one or more of the interaction events of the internal executable resource data 119.

At operation 506 of the process 500, the external service communication server 106 determines an external service 150 of the plurality of external services 150A-150N to which the external service candidate communication 462 should be transmitted. In one example, the external service communication server 106 may be configured to determine the external service 150 to which the external service candidate communication 462 should be transmitted based at least in part on the candidate communication corpus 117, the communication corpus metadata 118, the internal executable resource data 119, and/or the candidate selection score 460 and/or candidate selection context 461 generated for the external service candidate communication 462.

At operation 508 of the process 500, the external service communication server 106 generates the external service candidate communication 462 based at least in part on the candidate selection score 460 (e.g., generated for the external service candidate communication 462 at operation 502), the candidate selection context 461 (e.g., generated for the external service candidate communication 462 at operation 504), and the determined external service 150 to which the external service candidate communication 462 should be transmitted (e.g., determined for the external service candidate communication 462 at operation 506).

The external service candidate communication 462 generated at operation 508 may comprise one or more renderable content identifiers for requesting renderable content (e.g., from the renderable content server 112 or another content server internal or external to the executable resource management system 105), which may be presented within an interface subsequent to transmission of the external service candidate communication 462 to the external service 150. The external service candidate communication 462 generated at operation 508 may comprise one or more candidate elements extracted from the candidate communication corpus 117 and/or associated with the candidate selection score, which may cause the renderable content (e.g., identified via the one or more renderable content identifiers of the external service candidate communication) to be presented in certain situations associated with the one or more candidate elements included in the external service candidate communication 462.

In another example, the external service candidate communication 462 generated at operation 508 may constitute and/or comprise a communication opportunity request representing a request for the renderable content (e.g., identified via the one or more renderable content identifiers of the external service candidate communication) to be presented according to a requested transaction associated with the external service candidate communication 462. In some embodiments, the external service candidate communication 462 may comprise various attributes associated with, representing, indicative of, and/or characterizing the requested transaction, including, for example, an exchange value representing an amount of a medium exchange (e.g., a monetary value) transferred from an entity associated with the executable resource management system 105 to an external entity (e.g., associated with the external service 150) in conjunction with presenting the renderable content identified in the external service candidate communication 462.

In yet another example, in generating the external service candidate communication 462 at operation 508, the external service communication server 106 may determine one or more renderable content identifiers included in the external service candidate communication based at least in part on the candidate selection context 461 generated for the external service candidate communication at operation 504. In another example, in generating the external service candidate communication 462 at operation 508, the external service communication server 106 may determine one or more candidate elements (e.g., extracted from raw text objects of the candidate communication corpus 117) to be included in the external service candidate communication 462 based at least in part on a candidate selection score 460 (e.g., generated at operation 502) associated with one or more of the candidate elements. In yet another example, in generating the external service candidate communication 462 at operation 508, the external service communication server 106 may determine a requested transaction of the external service candidate communication 462 and/or attributes associated with the requested transaction (e.g., the exchange value) based at least in part on the candidate selection score 460 (e.g., generated at operation 502) and/or the candidate selection context 461 (e.g., generated at operation 504) for the external service candidate communication 462, and/or based at least in part on the determined external service 150 to which the communication 462 is to be transmitted (e.g., determined at operation 506).

At operation 510 of the process 500, the external service communication server 106 transmits the external service candidate communication 462 (e.g., generated at operation 508) to the external service 150 (e.g., determined at operation 506).

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

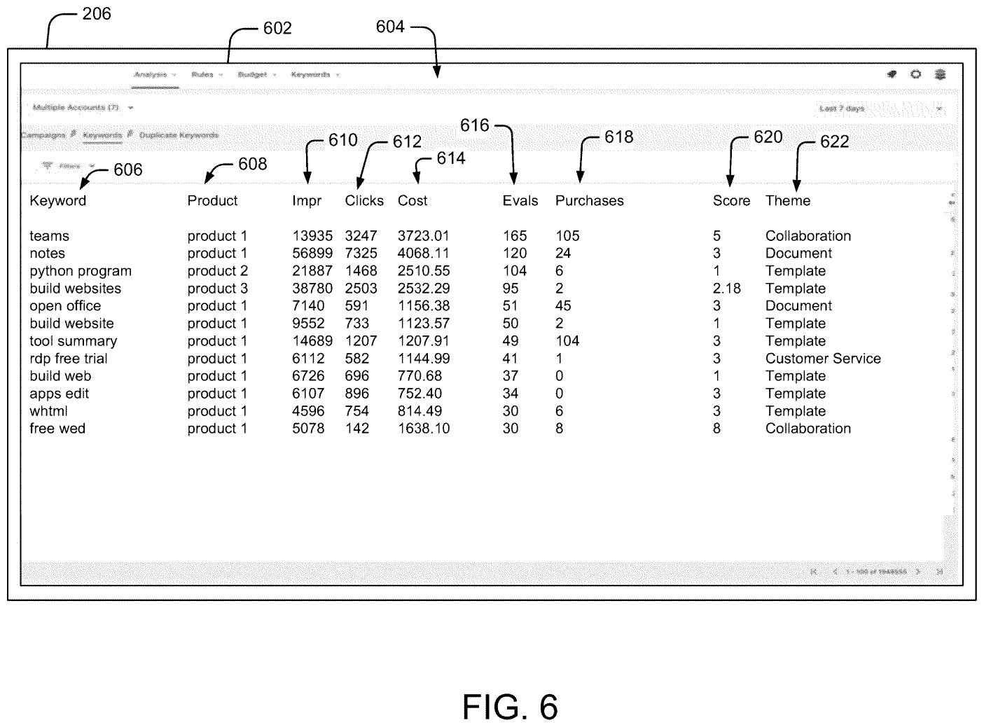

FIG. 6 is an illustration of an exemplary score presentation interface 604 of a graphical user interface (GUI) 602 presented by the executable resource management system 105. The GUI 602 may be rendered on a display of a computing device, for example, via the input/output circuitry 206 of the apparatus 200. The score presentation interface 604 is used to present candidate selection scores and other data concerning external service candidate communications 462 and/or the data used to generate the scores and/or communications 462 according to at least some embodiments of the present disclosure.

In the illustrated example, the score presentation interface 604 presents the data in the form of a table, which includes a keyword column 606, a product column 608, an impressions column 610, a clicks column 612, a cost column 614, an evaluations column 616, a purchases column 618, a score column 620, and a theme column 622. Each of the columns corresponds to a different attribute for objects represented by each row. The objects represented by each row may be candidate elements (e.g., keywords) and/or a set of external service candidate communications 462 associated with each of the candidate elements.

The keyword column 606 identifies, at each row, the candidate element (e.g., keyword) to which the various attributes within the same row pertain. The candidate elements listed under the keyword column 606 may be identified by the actual values of the candidate elements (e.g., string values constituting each candidate element). In the illustrated example, data is provided for a “teams” candidate element, a “notes” candidate element, a “python program” candidate element, a “build websites” candidate element, an “open office” candidate element, a “build website” candidate element, a “tool summary” candidate element, an “rdp free trial” candidate element, a “build web” candidate element, an “apps edit” candidate element, a “whtml” candidate element, and a “free wed” candidate element. The candidate elements may be extracted from raw text objects of the candidate communication corpus 117, which raw text objects may be received via user interfaces (e.g., of instances and/or components of the plurality of internal executable resources, of renderable content for presenting data about the plurality of internal executable resources). The candidate elements and/or the raw text objects from which the candidate elements are extracted may be included and/or referred to in the communication corpus metadata 118 and/or the internal executable resource data 119, for example, as part of or in association with interaction events captured by the executable resource management system 105. The candidate elements may be provided by an external data source 302.

The product column 608 identifies, at each row, a selected one of the plurality of internal executable resources to which the identified candidate element for that row is associated. In some embodiments, the selected one of the plurality of internal executable resources may be determined based at least in part on a candidate selection context 461 associated with the candidate element and/or selected internal executable resource.

The impressions column 610, clicks column 612, cost column 614, evaluations column 616, and purchases column 618 each identify, at each row, a quantity characterizing one or more external service candidate communications 462 associated with the identified candidate element for that row and/or any detected and/or measured events or effects occurring subsequent to and/or resulting from transmission of the external service candidate communications 462 to the external services 150A-150N and/or presentation of renderable content (e.g., associated with the selected internal executable resource), including any electronic interactions with the presented renderable content. In particular, the impressions column 610 may indicate a quantity of occurrences of presentation of the renderable content associated with the selected internal executable resource, the clicks column 612 may indicate a quantity of electronic interactions with the presented renderable content, the cost column 614 may indicate a quantity or amount of an exchange value (e.g., monetary value) associated with the set of external service candidate communications 462 pertaining to the keyword identified in each row (e.g., a total amount transferred from an entity associated with the executable resource management system 105 to an external entity in conjunction with presenting the renderable content identified in the set of external service candidate communications 462), the evaluations column 616 may indicate a quantity of occurrences of electronic interactions with the presented renderable content associated with the selected internal executable resources that resulted in an evaluation transaction (e.g., an initiation of a trial or evaluation period for a downloaded copy and/or component of the selected internal executable resource), and the purchases column 618 may indicate a quantity of occurrences of electronic interactions with the presented renderable content associated with the selected internal executable resources that resulted in a purchase transaction (e.g., a purchase of a downloaded copy and/or component of the selected internal executable resource, a purchase of a license or subscription for accessing locally and/or remotely executing instances and/or components of the selected internal executable resource).

The score column 620 identifies, at each row, a candidate selection score associated with the candidate element and/or selected internal executable resource for that row. In particular, the candidate selection scores identified in the score column 620 in the illustrated example correspond to candidate selection scores representing a programmatically generated likelihood that renderable content associated with an internal executable resource and transmitted for presentation within an interface will result in an electronic interaction with the renderable content subsequent to transmission of the external service candidate communication to the external service.

The theme column 622 identifies, at each row, a candidate selection score, namely a candidate selection classification 460, associated with the candidate element and/or selected internal executable resource for that row. In particular, the candidate selection classifications 460 identified in the theme column 622 may include the candidate selection classifications 460 (e.g., generated by the classification model 402b) and/or may correspond to classification labels assigned to each of the candidate elements and/or selected internal executable resource, particularly classification labels characterizing associated communication themes and/or associated communication operations. In the illustrated example, the candidate selection classifications 460 indicated in the theme column 622 include a “Collaboration” theme, a “Document” theme, a “Template” theme, and a “Customer Service” theme.

The score presentation interface 604 may be configured to present any other types or examples of candidate selection scores representing any other aspects of candidate elements, internal executable resources, and/or external service candidate communications.

Any of the data provided in each of the columns may be retrieved from and/or determined based on the bodies of data provided in the candidate communication corpus 117, the communication corpus metadata 118, and/or the internal executable resource data 119.

In some embodiments, the score presentation interface 604 may present for each of the candidate elements (e.g., keywords) one or more attributes associated with the candidate elements, including via the candidate selection classifications 460, such as a communication operation (e.g., campaign) to which the candidate element is assigned, a language associated with the candidate element, and/or weighted conversion values associated with the candidate element (e.g., an amount of a medium exchange such as currency associated with an inferred value or worth of the candidate element).

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web components, web services, web microservices, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. A processor will receive instructions and information/data from a read-only memory, a random access memory, or both. The essential elements of a computer are a processor for performing actions in accordance with instructions and one or more memory devices for storing instructions and data. A computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are typically remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can be integrated together in a product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory computer-readable storage medium storing instructions that, when executed by the at least one processor, cause the apparatus to:
for each external service candidate communication of a plurality of external service candidate communications,
generate one or more candidate selection scores associated with a candidate element of one or more candidate elements using one or more trained candidate selection scoring models;
generate one or more candidate selection contexts, wherein each candidate selection context comprises a mapping of the candidate element with an internal executable resource of a plurality of internal executable resources, wherein the candidate selection context is generated based at least in part on communication corpus metadata and internal executable resource data, wherein the internal executable resource data comprises interaction events representing electronic interactions performed by client computing devices with respect to one or more internal executable resources of the plurality of internal executable resources;
determine an external service of a plurality of external services to which the external service candidate communication should be transmitted;
generate the external service candidate communication based at least in part on the one or more candidate selection scores, the one or more candidate selection contexts, and the determined external service to which the external service candidate communication should be transmitted, wherein the external service candidate communication comprises the candidate element; and
transmit the external service candidate communication to the external service.

2. The apparatus of claim 1, wherein at least one candidate selection score of the one or more candidate selection scores represents a classification of the candidate element associated with the at least one candidate selection score, wherein the classification is generated based at least in part on semantic similarities between the candidate element and one or more previously classified candidate elements.

3. The apparatus of claim 2, wherein a candidate selection scoring model or the one or more trained candidate selection scoring models is trained using a candidate communication corpus, and wherein the semantic similarities between the candidate element associated with the at least one candidate selection score and the one or more previously classified candidate elements are determined using the candidate selection scoring model.

4. The apparatus of claim 3, wherein determining the semantic similarities between the candidate element and the one or more previously classified candidate elements comprises vectorizing the candidate element and the one or more previously classified candidate elements using the candidate selection scoring model.

5. The apparatus of claim 2, wherein generating the at least one candidate selection score comprises calculating a cosine similarity between a candidate element context of the candidate element and one or more candidate element contexts of the one or more previously classified candidate elements.

6. The apparatus of claim 2, wherein generating the at least one candidate selection score comprises:
selecting a previously classified candidate element of the one or more previously classified candidate elements, wherein the selected previously classified candidate element comprises a degree of semantic similarity with the candidate element that is highest among the one or more previously classified candidate elements; and
assigning a classification label to the candidate element matching a classification label associated with the selected previously classified candidate element.

7. The apparatus of claim 2, wherein generating the at least one candidate selection score comprises assigning a classification label indicating creation of a new classification category to the candidate element in response to determining that none of the one or more previously classified candidate elements has a degree of semantic similarity with the candidate element that satisfies a predetermined similarity threshold.

8. The apparatus of claim 1, wherein the candidate element is extracted from one or more raw text objects of a candidate communication corpus.

9. The apparatus of claim 8, wherein the one or more candidate selection contexts are generated based at least in part on communication corpus metadata that associates the one or more raw text objects with one or more internal executable resources of the plurality of internal executable resources.

10. The apparatus of claim 8, wherein the one or more candidate selection contexts are generated based at least in part on communication corpus metadata that associates the one or more raw text objects of the candidate communication corpus to one or more of the interaction events of the internal executable resource data.

11. A computer-implemented method, comprising:
for each external service candidate communication of a plurality of external service candidate communications,
generate one or more candidate selection contexts, wherein each candidate selection context comprises a mapping of the candidate element
generating, by one or more processors, one or more candidate selection scores associated with a candidate element of one or more candidate elements using one or more trained candidate selection scoring models;
generating, by one or more processors, one or more candidate selection contexts, wherein each candidate selection context comprises a mapping of the candidate element with an internal executable resource of a plurality of internal executable resources, wherein the candidate selection context is generated based at least in part on communication corpus metadata and internal executable resource data, wherein the internal executable resource data comprises interaction events representing electronic interactions performed by client computing devices with respect to one or more internal executable resources of the plurality of internal executable resources;
determining, by one or more processors, an external service of a plurality of external services to which the external service candidate communication should be transmitted;
generating, by one or more processors, the external service candidate communication based at least in part on the one or more candidate selection scores, the one or more candidate selection contexts, and the determined external service to which the external service candidate communication should be transmitted, wherein the external service candidate communication comprises the candidate element; and
transmitting, by one or more processors, the external service candidate communication to the external service.

12. The computer-implemented method of claim 11, wherein at least one candidate selection score of the one or more candidate selection scores represents a classification of the candidate element associated with the at least one candidate selection score, wherein the classification is generated based at least in part on semantic similarities between the candidate element and one or more previously classified candidate elements.

13. The computer-implemented method of claim 12, wherein a candidate selection scoring model of the one or more trained candidate selection scoring models is trained using a candidate communication corpus, and wherein the semantic similarities between the candidate element associated with the at least one candidate selection score and the one or more previously classified candidate elements are determined using the candidate selection scoring model.

14. The computer-implemented method of claim 13, further comprising determining the semantic similarities between the candidate element and the one or more previously classified candidate elements by vectorizing the candidate element and the one or more previously classified candidate elements using the candidate selection scoring model.

15. The computer-implemented method of claim 12, wherein generating the at least one candidate selection score comprises calculating a cosine similarity between a candidate element context of the candidate element and one or more candidate element contexts of the one or more previously classified candidate elements.

16. The computer-implemented method of claim 12, wherein generating the at least one candidate selection score comprises:
selecting a previously classified candidate element of the one or more previously classified candidate elements, wherein the selected previously classified candidate element comprises a degree of semantic similarity with the candidate element that is highest among the one or more previously classified candidate elements; and
assigning a classification label to the candidate element matching a classification label associated with the selected previously classified candidate element.

17. The computer-implemented method of claim 12, wherein generating the at least one candidate selection score comprises assigning a classification label indicating creation of a new classification category to the candidate element in response to determining that none of the one or more previously classified candidate elements has a degree of semantic similarity with the candidate element that satisfies a predetermined similarity threshold.

18-19. (canceled)

20. The computer-implemented method of claim 11, wherein the candidate element is extracted from one or more raw text objects of a candidate communication corpus, and wherein the one or more candidate selection contexts are generated based at least in part on communication corpus metadata that associates the one or more raw text objects of the candidate communication corpus to one or more of the interaction events of the internal executable resource data.

21. A non-transitory computer readable storage medium comprising instructions that, when executed by one or more processors, cause the one or more processors to:
for each external service candidate communication of a plurality of external service candidate communications,
generate one or more candidate selection scores associated with a candidate element of one or more candidate elements using one or more trained candidate selection scoring models;
generate one or more candidate selection contexts, wherein each candidate selection context comprises a mapping of the candidate element with an internal executable resource of a plurality of internal executable resources, wherein the candidate selection context is generated based at least in part on communication corpus metadata and internal executable resource data, wherein the internal executable resource data comprises interaction events representing electronic interactions performed by client computing devices with respect to one or more internal executable resources of the plurality of internal executable resources;
determine an external service of a plurality of external services to which the external service candidate communication should be transmitted;
generate the external service candidate communication based at least in part on the one or more candidate selection scores, the one or more candidate selection contexts, and the determined external service to which the external service candidate communication should be transmitted, wherein the external service candidate communication comprises the candidate element; and
transmit the external service candidate communication to the external service.

22. The apparatus of claim 1, wherein a candidate selection score of the one or more candidate selection scores represents a programmatically generated likelihood that renderable content associated with the candidate element and internal executable resource and transmitted for presentation within an interface will result in an electronic interaction with the renderable content subsequent to transmission of the external service candidate communication to the external service.
